(19) United States
(12) Patent Application Publication
(10) Pub. No.: US 2005/0280848 A1
(43) Pub. Date: Dec. 22, 2005

(54) Color conversion method, color conversion device, printing control device, and program recording medium

(75) Inventor: Masayuki Seko, Suwa-shi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 11/142,662

(22) Filed: Jun. 2, 2005

(30) Foreign Application Priority Data
Jun. 2, 2004 (JP) 2004-164782

(51) Int. Cl. H04N 1/60

(52) U.S. Cl. 358/1.9; 358/518

(57) ABSTRACT

The gamut G1 of the monitor (the first image equipment) is mapped for making the lightness at the maximum color saturation point P11 in the monitor gamut G1 agree with the lightness at the maximum color saturation point P13 in the printer (second image equipment) gamut G3 in the same hue, then said post-mapping gamut G2 is mapped in the printer gamut G3 to specify the correspondence relationship between the color gamut of the monitor and that of the printer, and the RGB data (the first image data) are color converted into the amount of ink data (the second image data) according to the correspondence relationship specified thereby.

### BACKGROUND OF THE INVENTION

1. Field of the Invention

The present invention relates to a color conversion method, a color conversion device, and a printing control device for converting the colors of image data among the color reproduction gamuts of different image equipment and a medium for recording the program thereof.

2. Description of the Related Art

Image equipment such as displays, printers and the like have different color reproduction gamuts (gamut) or color ranges that can be expressed depending on their type. For converting the color of image data among the color reproduction gamuts of different image equipment, a color conversion LUT (color conversion look up table) specifying the correspondence relationship of color reproduction gamuts among image equipment is made so that each image may seem to have almost the same color on each image equipment and the color of image data is converted based on this color conversion LUT.

And according to Japanese Patent Application Laid Open 2002-359748, when a color reproduction gamut is outside of the color reproduction gamut of a display and within the color reproduction gamut of a printer of the same hue, a color shifting operation and a color gamut expansion operation are performed successively in order to make a color conversion LUT specifying the relationship of correspondence of the color reproduction gamut of the display and the color reproduction gamut of the printer. Here, a color gamut shifting operation is an operation of reducing somewhat the lightness of the color reproduction gamut of the display so that the form of the color reproduction gamut of the display may be brought closer to the form of the color reproduction gamut of the printer in the same hue and to obtain a map emphasizing the color saturation thereof. And the color gamut expansion operation is an operation of obtaining a map for expanding the area obtained as a result of a color gamut shifting operation to within the color reproduction gamut of the printer. The application of the art described in the patent application mentioned above enables effectively to use the color outside the color reproduction gamut of the display and within the color reproduction gamut of the printer.

Now that higher picture quality of image is required in recent years, it has been hoped to improve easily the gradation of lightness in high color saturation areas in images after color conversion. And it has also been desired to make it easy to design and create colors in the color reproduction gamuts of image equipment outputting images before color conversion.

### SUMMARY OF THE INVENTION

The present invention has been made in view of the issues mentioned above, and its object is to improve easily the gradation of light and shade in high color saturation areas in images after color conversion.

In order to achieve the object mentioned above, one aspect of the present invention resides in a color conversion method for color converting first image data expressing color image in a color reproduction gamut of a first image equipment into second image data expressing color image in a color reproduction gamut of a second image equipment, comprising color converting the first image data into the second image data according to a correspondence relationship between the color reproduction gamut of the first image equipment and that of the second image equipment. The relationship is specified by: mapping the color reproduction gamut of the first image equipment in such a way as to make the lightness at the maximum color saturation point in the color reproduction gamut of the first image equipment agree with the lightness at the maximum color saturation point in the color reproduction gamut of the second image equipment while keeping the same hue before and after the mapping; and thereafter mapping the post-mapping color reproduction gamut in the color reproduction gamut of the second image equipment.

Another aspect of the present invention resides in a color conversion device for color converting the first image data expressing color images in the color reproduction gamut of the first image equipment into the second image data expressing color images in the color reproduction gamut of the second image equipment having a correspondence specification unit and a color conversion unit.

After the correspondence specification unit specifying the correspondence relationship between the color reproduction gamut of the first image equipment and that of the second image equipment carried out the first-stage mapping of the color reproduction gamut of the first image equipment in the same hue, the second-stage mapping of the post-mapping color reproduction gamut of the second image equipment takes place in the color reproduction gamut of the second image equipment to specify the correspondence relationship between both color reproduction gamuts. And the color conversion unit converts the color of the first image data into that of the second image data according to the specified correspondence relationship.

The first stage mapping is made by making the lightness at the maximum color saturation point in the color reproduction gamut of the first image equipment agree with the lightness at the maximum color saturation point in the color reproduction gamut of the second image equipment. As this can increase the overlapping area of the post-mapping color reproduction gamut and the color reproduction gamut of the second image equipment particularly in high color saturation areas, it will be possible to easily improve the gradation of lightness in high color saturation areas in images after color conversion (also referred to as “color converted images”) outputted in response to the second image data. And the area where no emphasis of color saturation is required when the value of color saturation is to be increased in the second stage mapping increases, and in this respect it becomes possible to obtain color-converted images of a more natural color quality.

The first image equipment or the second image equipment may take the form of image display devices such as displays and the like, printing devices such as printers and the like, image reproducing devices such as scanner, digital camera and the like. And both image equipment maybe not only separate-type equipment but may be a part of integrated equipment such as facsimile made by integrating an image forming device and a printing device.

The first image data and the second image data may be, for example, image data the color image of which is expressed by the quantity of color components for each picture element or pixel. It is enough that the picture element be a number capable of expressing an image, and may be for example 8×8 pixels expressing a small image. The quantity of color components may be, for example, a quantity of color components in a pre-determined color space consisting of a plurality of color components as the quantity of color components.

When the correspondence specification unit maps a color reproduction gamut with the same hue of a color space independent from equipment not dependent on devices, it is useful in that a better color reproducibility can be obtained by color-converted images. It is possible, however, to map the color reproduction gamut with the same hue of a color space independent from equipment depending on a device. Here, a space dependent on equipment may be CIE L*a*b* color space, CIE L*u*v* color space, CIE XYZ color space and the like specified by the International Commission on Illumination (C.I.E.) . Here, L* is an element color representing lightness (brightness), and a*, b*, u*, and v* are element colors representing hues and color saturation. Hereinafter, these element colors will be referred to by omitting “*”.

Although the correspondence specification unit does not actively engage itself in any operation of changing hue, it does not inhibit actual hue from shifting before and after the color conversion due to the nature of the color space serving as the reference, mechanical errors of the image equipment involved and so forth. It is possible that actual hue may change by 0-10° even if no active action is taken to change the hue.

The correspondence specification unit may make color conversion data specifying the correspondence relationship of color reproduction gamut of the first image equipment with that of the second image equipment for a plurality of reference points, and the color conversion unit may color convert the first image data into the second image data according to the correspondence relationship described above by referring to the color conversion data. It will be possible to convert the color of image data according to a simple method of referring to the color conversion data obviously, a predetermined conversion formula may be used to convert the color of image data, and to specify the correspondence relationship of color reproduction gamuts by referring to the parameters used in the conversion formula.

The correspondence specification unit includes a first correspondence specification unit for specifying the first correspondence relationship between the color reproduction gamut of the first image equipment and the post-mapping color reproduction gamut by mapping the color reproduction gamut of the first image equipment for making the lightness at the maximum color saturation point in the color reproduction gamut of the first image equipment agree with the lightness at the maximum color saturation point in the color reproduction gamut of the second image equipment in the same hue, and a second correspondence specification unit for specifying the second correspondence relationship between the color reproduction gamut of the second image equipment and the post-mapping color reproduction gamut by mapping the post-mapping color reproduction gamut in the color reproduction gamut of the second image equipment in the same hue so that the correspondence relationship between the color reproduction gamut of the first image equipment and the color reproduction gamut of the second image equipment may be specified by the first correspondence relationship and the second correspondence relationship. Then, it will be possible to provide easily a concrete example of improving the gradation of lightness in high color saturation areas in images after color conversion (referred also as “color-converted images”).

The correspondence specification unit may specify relationship of correspondence by carrying out mappings for making the lightness of the maximum color saturation described above agree for all the hues, or may specify relationship of correspondence by carrying out mappings for making the lightness at the maximum color saturation described above agree for a limited number of hues. And for this end, upon carrying out mapping for making the lightness at the maximum color saturation point in the color reproduction gamut of the first image equipment agree with the lightness at the maximum color saturation point in the color reproduction gamut of the second image equipment in the same hue in a limited number of hues out of all the hues, the correspondence specification unit may specify the correspondence relationship between the color reproduction gamut of the first image equipment and that of the second image equipment by mapping the post-mapping color reproduction gamut in the color reproduction gamut of the second image equipment, and may specify the correspondence relationship of the color reproduction gamut of the first image equipment and that of the second image equipment regarding the remaining hues except some hues among all the hues based on the correspondence relationship specified with regards to some hues.

In other words, for a limited number of hues it becomes possible to improve easily the gradation of lightness in high color saturation areas in color-converted images outputted in response to the second image data, and in case where color saturation is to be increased in the second mapping, area requiring no emphasis of color saturation increases. And as for the remaining hues, in view of the fact that the correspondence relationship of different color reproduction gamuts is specified based on the correspondence relationship specifying such a part of hues, it becomes possible to specify quickly the correspondence relationship for all the hues.

Here, when some hues described above are taken as mutually different N types (N is an integer equal to or larger than 3) of reference hues and the remaining hues are intermediate hues excluding the N types of reference hues among all the hues, the correspondence specification unit may carry out a predetermined interpolating calculation using parameters representing an amount of variation in at least one of lightness or color saturation before and after the mapping represented by the correspondence relationship specifying at least a part of the N types of reference hues and the hues specifying the correspondence relationship, calculate the amount of variation in at least one of lightness or color saturation before and after the mapping for the intermediate hue, and specify the correspondence relationship between the color reproduction gamut of the first image equipment and that of the second image equipment in such a way that the amount of variation in at least one of lightness or color saturation before and after the capping for the intermediate hues may be the amount of variation calculated. Regarding intermediate hues other than the reference hues, the amount of variation in lightness by the reference hues, the amount of variation in color saturation by the reference hue, or the amount of variation in lightness and the amount of variation in color saturation by the reference hue, and parameters representing the hues of the reference hues corresponding to the amount of variation (for example hue angle) may be used to carry out the predetermined interpolating calculation, and the correspondence relationship is specified in such a way that the amount of variation in lightness obtained, the amount of variation in color saturation obtained, or the amount of variation in lightness and the amount of variation in color saturation obtained may result from the same. This will enable to improve easily the gradation of lightness in high color saturation areas in the color-converted images outputted in response to the second image data without causing any degradation in the color reproducibility of output images in the first image equipment at the time of color reproduction by the second image equipment and to obtain color-converted images of a more natural image quality.

Incidentally, the prescribed interpolating calculation may take the form of an interpolating calculation based on linear interpolating using the amount of variation in at least one of lightness or color saturation by two types of reference hues sandwiching (enclosing) the intermediate hue and parameters representing the hue of the two types of reference hues, an interpolating calculation based on spline interpolating using the amount of variation in at least one of lightness or color saturation by three or more types of reference hues and parameters representing the hue of the three or more types of reference hues and the like.

The correspondence specification unit may specify the correspondence relationship by mapping the color reproduction gamut of the first image equipment by making the color saturation at the maximum color saturation point in the color reproduction gamut of the first image equipment exceed the color saturation at the maximum color saturation point in the color reproduction gamut of the second image equipment to specify the correspondence relationship. Since this enables to increase with a higher certainty the overlapping area of the post-mapping color reproduction gamut in high color saturation areas with the color reproduction gamut of the second image equipment, it will be possible to improve more easily the gradation of light and shade in high color saturation area in color-converted images.

The correspondence specification unit may map the color reproduction gamut of the first image equipment in such a way that post-mapping color saturation may be more intense than color saturation before the mapping by maintaining the intensity relation of lightness before and after the mapping in the same hue in the color reproduction gamut of the first image equipment. With regards to the state of maintenance of intensity relation of lightness before and after the mapping, when any random two points P1 and P2 are taken in a color reproduction gamut before mapping and the post-mapping points of the points P1 and P2 are called P1′ and P2′, if the lightness at the point P1 is more intense than that of the point P2, the lightness at the point P1′ will be greater than that at the point P2′, and if the lightness at the point P1 is smaller than that at the point P2, the lightness at the point P1′ will also be smaller than that at the point P2′, and when the lightness at the point P1 is the same as that at the point P2, the lightness at the point P1′ will be the same as that at the point P2′. The same thing holds true hereafter. Since this enables to increase with a higher certainty the overlapping area of the post-mapping color reproduction gamut in high color saturation areas with the color reproduction gamut of the second image equipment, it will be possible to improve more easily the gradation of light and shade in high color saturation area in color-converted images.

The correspondence specification unit may map the color reproduction gamut of the first image equipment to make the color saturation agree before and after the mapping in the same hue. Even if an upper ceiling is set for color saturation by proceeding to the first stage mapping by storing the color saturation, it will be possible to improve easily the gradation of light and shade in high color saturation areas in color-converted images.

The correspondence specification unit may map the post-mapping color reproduction gamut in such a way that, if the lightness before the mapping is different, post-mapping lightness may be also different in the same hue maintaining one-to-one relations. In other words, the correspondence specification unit may map the post-mapping color reproduction gamut in such a way that a plurality of points of mutually different lightness before the mapping may be converted into a plurality of points of mutually different lightness after the mapping in the same hue. As lightness does not diminish at the second stage mapping, it will be possible to improve more easily the gradation of light and shade in high color saturation areas in color-converted images.

The correspondence specification unit may map the post-mapping color reproduction gamut by maintaining the intensity relations of lightness in the same hue before and after the mapping. Then, due to the possibility of maintaining the gradation of lightness, it will be possible to improve more easily the gradation of light and shade in high color saturation areas in color-converted images.

In addition, when the post-mapping color reproduction gamut is mapped in such a way that lightness may be maintained before and after the mapping in the same hue, it will be possible to improve more easily the gradation of light and shade in high color saturation areas in color-converted images.

The correspondence specification may map the post-mapping color reproduction gamut by maintaining the intensity relations of color saturation before and after the mapping in the same hue. Then, due to the fact that the intensity relationship of lightness and color saturation in the color reproduction gamut of the first image equipment and that of the second image equipment is maintained, color saturation and lightness that express the color reproduction gamut of the second image equipment increase monotonously or decrease monotonously (vary monotonously) in comparison with the amount of each color component that expresses the color reproduction gamut of the first image equipment and the variation in color saturation or lightness obtained from the amount of each color component, it will be easy to design or make colors in the color reproduction gamut of the first image equipment.

The correspondence specification unit may specify the correspondence relationship in such a way that at least one of lightness or color saturation may be maintained in the predetermined areas of the low color saturation part of the color reproduction gamut of the first image equipment. Due to the constancy of colors of low color saturation important in terms of image quality such as colorlessness, flesh color and the like, it will be possible to obtain color-converted images of a better image quality.

The correspondence specification unit may map the color reproduction gamut of the first image equipment by making the difference in lightness before and after the mapping grow larger as the color saturation grows greater in the same hue in areas of varying lightness where lightness is varied before and after the mapping in the color reproduction gamut of the first image equipment. Then, it will be possible to obtain color-converted images of more natural image quality.

The correspondence specification unit may map the color reproduction gamut of the first image equipment by making the difference in lightness before and after the mapping grow larger in comparison with the variation in color saturation as color saturation grows greater in the same hue in the area of variation in lightness. Then, it will be possible to obtain color-converted images of more natural image quality.

When the area of variation of lightness covers areas excludes predetermined areas on the low color saturation of the color reproduction gamut of the first image equipment, with pre-mapping color saturation being represented by Cin, pre-mapping lightness by Lin, color saturation at the boundary between the variable lightness area and the predetermined area by Co, color saturation at the maximum color saturation point in the color reproduction gamut of the first image equipment by Cm1, lightness at the maximum color saturation point by Lm1, and lightness at the maximum color saturation point in the second image equipment by Lm2,

the mapping may be made in such a way that post-mapping lightness may be Lin+ΔL by calculating the difference in lightness ΔL before and after the mapping by a function ΔL(Cin) that satisfies:
ΔL(Co)=0, ΔL(Cm1)=Lm2−Lm1 (ii)

(ii) The inclination of the curve ΔL=AL(Cin) in Cin=Co on the plane surface Cin−ΔL is 0. and,

(iii) In the case of Lm2<Lm1 and when Co<Cin<Cm1, the inclination of the curve ΔL=ΔL(Cin) on the plane surface Cin−ΔL is always negative and the curve ΔL=ΔL(Cin) is convex upward, and in the case of Lm2>Lm1, the other way around. Then, it will be possible to obtain color-converted images of a more natural image quality. And due to the fact that the variation of difference in lightness before and after the mapping in relation with the variation in color saturation for the boundary between the area of variation of lightness and the predetermined are reduced to zero, in this respect it will be possible to obtain color-converted images of a more natural image quality.

And even a color conversion device that maps the color reproduction gamut of the first image equipment making the lightness at the maximum color saturation point in the color reproduction gamut of the first image equipment agree with the lightness at the maximum color saturation point in the color reproduction gamut of the second image equipment in the same hue, maps the post-mapping color reproduction gamut on the color reproduction gamut of the second image equipment, and color converts the first image data into the second image data according to the specified correspondence relationship between the color reproduction gamut of the first image equipment and that of the second image equipment can also produce similar effects and actions.

Still another aspect of the present invention resides in a color conversion data making device for making color conversion data referred when the first image data are color converted into the second image data,

which maps the color reproduction gamut of the first image equipment by making the lightness at the maximum color saturation point in the color reproduction gamut of the first image equipment agree with the lightness at the maximum color saturation point in the color reproduction gamut of the second image equipment in the same hue and then maps the post-mapping color reproduction gamut on the color reproduction gamut of the second image equipment to make color conversion data specifying the correspondence relationship between the color reproduction gamut of the first image equipment and that of the second image equipment with regards to a plurality of reference points.

In other words, at the time of making color conversion data, it is possible to increase the extent of overlapping of the post-mapping color reproduction gamut with the color reproduction gamut of the second image equipment especially in high color saturation areas, and therefore it is possible to improve easily the gradation of light and shade in high color saturation areas in color-converted images.

The color conversion device and the color conversion data making device described above include various modes of carrying out such as possible combination with other methods being incorporated in some equipment. For example, they can be applied as a printing control device incorporating a color conversion device and a printing control unit for controlling a printing device to print image for printing corresponding to the second image data, and they can also be applied as a printing system provided with a printing device. And as it is also possible to proceed to process by following the predetermined procedure corresponding to the configuration of the devices described above, the present invention can be applied as a control method and has similar effects and actions. In addition, as the devices described above can be used for implementing control programs, they can be applied as programs, computer-readable recording media recording the same programs, and program products and have similar effects and actions.

Yet another aspect of the present invention resides in recording media for recording the color conversion data which has the configuration of mapping the color reproduction gamut of the first image equipment by making the lightness at the maximum color saturation point in the color reproduction gamut of the first image equipment agree with the lightness at the maximum color saturation point in the color reproduction area of the second image equipment while maintaining the intensity relationship in color saturation and the intensity relationship in lightness before and after the mapping in the same hue for maintaining lightness at the maximum color saturation point in the post-mapping color reproduction area before and after the mapping, of mapping then the post-mapping color reproduction gamut by maintaining the intensity relationship in color saturation and the intensity relationship in lightness before and after the mapping in the same hue and of specifying finally the correspondence relationship between the color reproduction gamut of the first image equipment and that of the second image equipment with regards to a plurality of reference points.

In other words, at the time of making color conversion data, it is possible to increase the extent of overlapping of the post-mapping color reproduction gamut with the color reproduction gamut of the second image equipment particularly in high color saturation area, and therefore it is possible to improve easily the gradation of light and shade in high color saturation areas in color-converted images. And as the intensity relationship of lightness and color saturation is maintained between the first image equipment and the second image equipment, it will be easy to design and develop colors in the color reproduction gamut of the first image equipment.

### BRIEF DESCRIPTION OF THE DRAWINGS

FIG. 1 is an illustration showing schematically the configuration of a color conversion device.

FIG. 2 is a block diagram showing the configuration of a printing system.

FIG. 3 is an illustration showing schematically how a color conversion LUT is generated from the correspondence-related data.

FIG. 4 is an illustration showing schematically how a color conversion LUT is generated from the correspondence-related data.

FIG. 5 is an illustration showing schematically a color reproduction gamut.

FIG. 6 is a flowchart showing the processing performed by a PC constituting a printing control device.

FIG. 7 is a flowchart showing the processing performed by a PC constituting a color conversion data making device.

FIG. 8 is a flowchart showing the process of making a LUT.

FIG. 9 is an illustration showing schematically the reference points created in a RGB color space.

FIG. 10 is a flowchart showing an intermediate color gamut mapping process.

FIG. 11 is a graphic illustration of an example of a curve ΔL=ΔL (Cin) on the Cin−ΔL plane surface.

FIG. 12 is a flowchart showing a printer color gamut mapping process.

FIG. 13 is an illustration showing schematically how lightness compensation amount and color saturation compensation amount are calculated by interpolating calculations.

FIG. 14 is a flowchart showing the first correspondence relationship specification process.

FIG. 15 is an illustration showing schematically a mapping in an intermediate color gamut mapping process in a variation example.

FIG. 16 is a flowchart showing the printing control process performed by a PC in another variation example.

### DETAILED DESCRIPTION

The embodiment of the present invention will be described by following the following order:

(1) Configuration of the printing system including a color conversion device;

(2) Color conversion data making process;

(3) Intermediate color gamut mapping process;

(4) Printer color gamut mapping process;

(5) The first and second correspondence relationship correlating process;

(6) Variation example:

(1) Configuration of the Printing System Including a Color Conversion Device

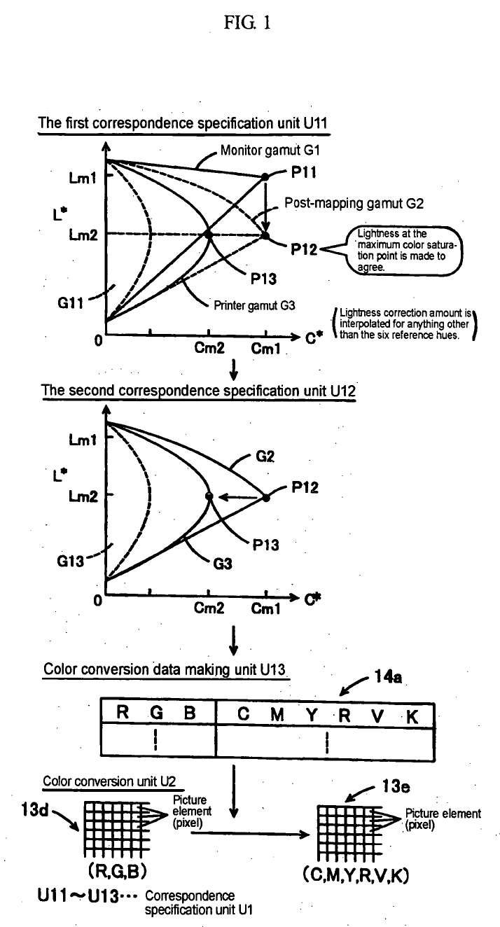

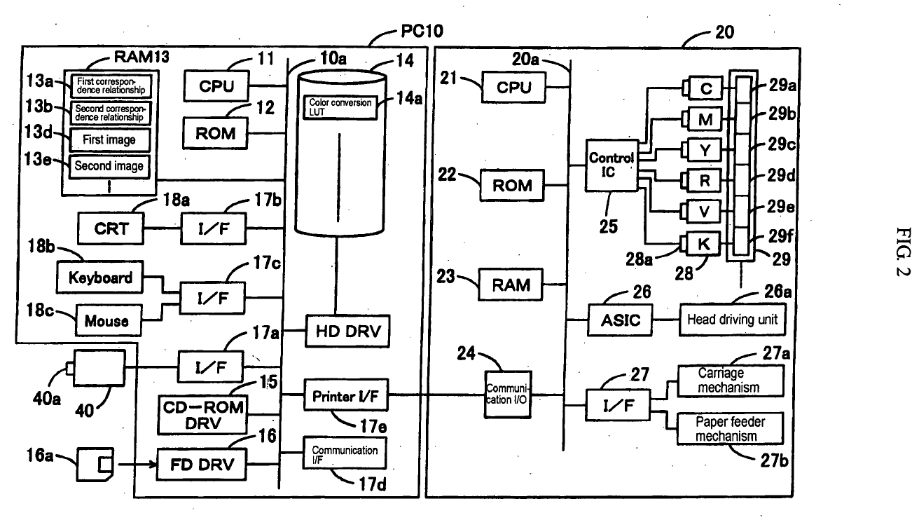

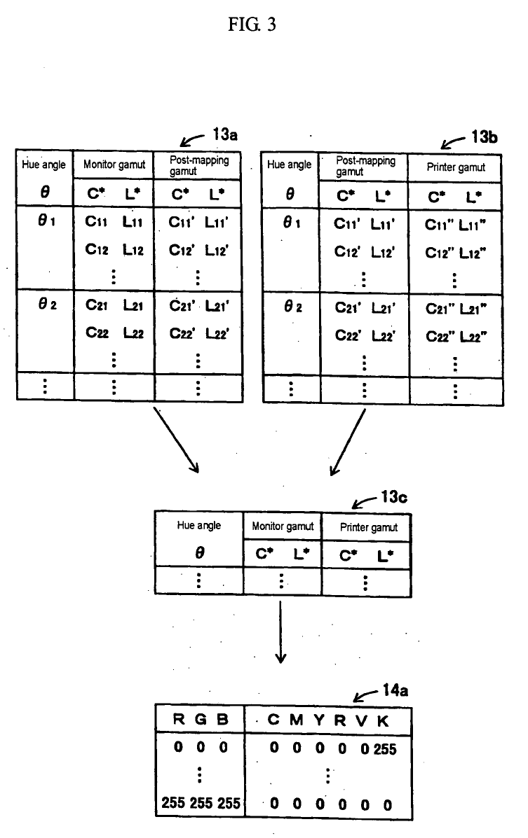

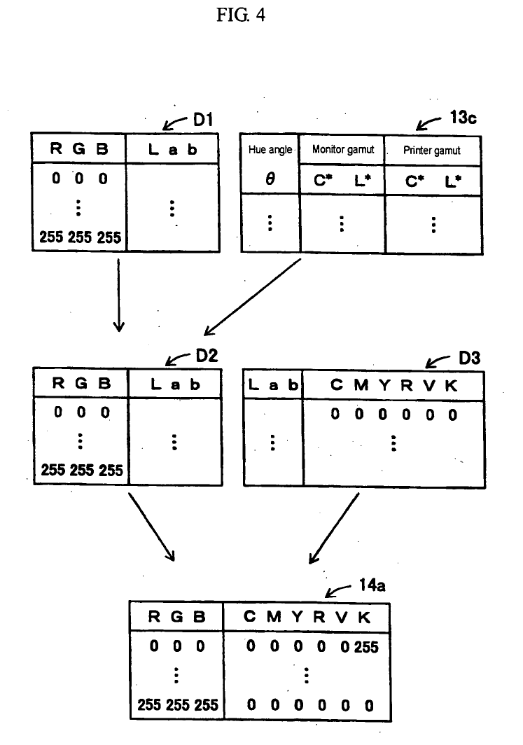

FIG. 1 is a configuration diagram of a color conversion device constituting an embodiment of the present invention, and FIG. 2 represents a printing system composed of a personal computer (PC) 10 serving as the color conversion device of the present invention, an ink jet printer 20 capable of color printing service as the printing device (printing unit) and the like in the present embodiment. FIG. 3 and FIG. 4 show how color conversion LUT (color conversion data) 14a are generated from the correspondence relationship data 13a and b specifying the correspondence relationship of color reproduction gamuts (referred hereinafter to also as “color gamuts”) . PC 10 has a bus 10a connected with a CPU 11, a ROM 12, a RAM 13 storing temporarily correspondence relationship data 13a˜c, the first image data 13d, the second image data 13e and the like, drives 15 and 16, interface (I/F) 17a˜e and the like. It is also connected with a hard disk HD 14 which is a magnetic disk through a hard disk drive, and the CPU 11 controls the whole PC. Needless to say, any computer other than PC may be used.

In the present embodiment, a color conversion device having a monitor (display) 18a as the first image equipment and a printer 20 as the second image equipment for color converting the first image data expressing the gradation of color images by the color component amount of each RGB (red, green and blue) in the gamut of the monitor (monitor gamut) into the second image data expressing the gradation of color images by the color component amount of each CMYRVK (cyan, magenta, yellow, red, violet, and black) in the gamut of the printer will be described.

HD 14 stores an operating system (OS), application programs (APL) and the like, which are transferred from time to time by the CPU 11 to the RAM 13 at the time of execution to be executed. HD 14 is a predetermined storage area storing the color conversion program, the color conversion LUT 14a and the like of the present invention. The present program may be constituted by any of OS, APL, or OS and APL. The medium recording the present program may be CD-ROM, flexible disk (FD) 16a, semiconductor memory and the like in addition to HD. And the program of the present invention may be downloaded from a predetermined server by connecting a communication I/F 17d to the Internet to be executed.

A colorimeter 40 connected to an I/F 17a (for example USB I/F) can acquire a plurality of color components L, a and b based on the Lab table color system according to the CIE (1976) standard as color component amounts (calorimetric values) by directing a color detection unit 40a to the object of color measurement and can output the acquired color component amounts L, a and b to the PC 10. Here, the CIE Lab color space is a uniform color space not dependent on devices consisting of a plurality of color components L, a and b as its color component amount. Incidentally L represents lightness and a, and b are color coordinates representing hue and color saturation respectively. Needless to say, the color space to be measured may be CIE XTZ color space, CIE Luv color space, RGB color space and the like.

The CRT I/F 17b is connected with a monitor 18a displaying images corresponding to the relevant data based on the color image data, and the input I/F 17c is connected with a keyboard 18b and a mouse 18c as operating input devices, and the printer I/F 17c is connected with a printer 20 through a cable (for example a serial I/F cable).

For the printer 20, it is possible to adopt an ink jet printer for printing images for printing corresponding to printing data expressing color images by discharging from a printing head a liquid ink filled in ink cartridges 28 respectively provided corresponding to for example each color ink of CMYRVK described above. Obviously it is possible to adopt a printer using also light cyan, light magenta, light black, dark yellow, uncolored ink and the like, or a printer using none of CMYRVK. And it is also possible to adopt a bubble jet printer discharging ink by generating bubbles in the pathway of ink or a laser printer using a toner ink.

The printer 20 is connected with each of the units 21-27 through the bus 20a, and the CPU 21 controls these units according to a program written in the ROM 22. The printer 20 receives raster data of separate color received from the PC 10 through the communication I/O 24 connected with the printer I/F 17e. When the ASIC 26 generates impressed voltage data corresponding to the raster data, the head driving unit 26a generates impressed voltage data for piezoelectric elements contained in the printing heads 29a˜f from the impressed voltage data and makes each ink filled in the ink chamber of the cartridge 28 from the corresponding head 29a˜f discharge by the dot. The carriage mechanism 27a and the paper feeding mechanism 27b connected with the I/F 27 control the printing head unit 29 to perform main scanning or secondary scanning of feeding successively printing paper by turning pages from time to time.

As shown in FIG. 1, the color conversion device of the present embodiment includes units U1 and U2, and the correspondence specification unit U1 includes further units U11-U13.

Generally, lightness at the maximum color saturation point of the monitor gamut and lightness at the maximum color saturation point of the printer color gamut are different. The first correspondence specification unit U11 specifies the first correspondence relationship between the monitor color gamut G1 and the post-mapping color gamut G2 by carrying out the first-stage mapping of the monitor color gamut G1 consisting of making the lightness Lm1 at the maximum color saturation point P11 in the monitor color gamut G1 agree with the lightness Lm2 at the maximum color saturation point P13 in the color gamut G3 of the printer in the same hue to generate the first correspondence relationship data 13a specifying the first correspondence relationship. Incidentally, each graph relating to units U11 and U′12 in the figure shows color gamut on the C-L plane surface passing through the color saturation C* (hereinafter C)=(a²+b²)^{1/2} axis and the lightness L axis at a hue angle θ=tan⁻¹ (b/a) of Lab color space. Here, the horizontal axis represents C and the vertical axis represents L. The hue to be mapped must be a hue of Lab color space that is a color space independent from equipment and a uniform color space in order to obtain color-converted images of a good color reproducibility. It is also possible to perform a mapping with a hue of color space dependent on equipment or a hue of color space that is not uniform color space. In specific terms, a hue angle θ that is a parameter representing hue in the Lab color space will be successively set and the lightness at the maximum color saturation points P1 and P13 will be made to agree for each hue angle θ. A preferable mapping for obtaining color-converted images of a good color reproducibility is a mapping of the monitor gamut G1 wherein the intensity relationship in color saturation C and the intensity relationship in lightness L are maintained before and after the mapping, a more preferable mapping is one wherein the post-mapping color saturation of the monitor gamut is in excess of the pre-mapping color saturation, and a further more preferable mapping is one that makes the color saturation of the monitor gamut before and after the mapping even.

As shown in FIG. 3, the first correspondence relationship data 13a constitute an information table storing a plurality of combinations of the color saturation C and lightness L of the corresponding monitor gamut and the color saturation C and lightness L of the post-mapping color gamut for every hue angle θ. For example, with regards to the hue angle θ1, the respective combination of the color saturation C1j′ and lightness L1j′ of the corresponding post-mapping color gamut for each combination of the color saturation C1j and light L1j of the monitor gamut are stored. Moreover, the correspondence relationship data 13b and c also constitute an information table having a similar data structure.

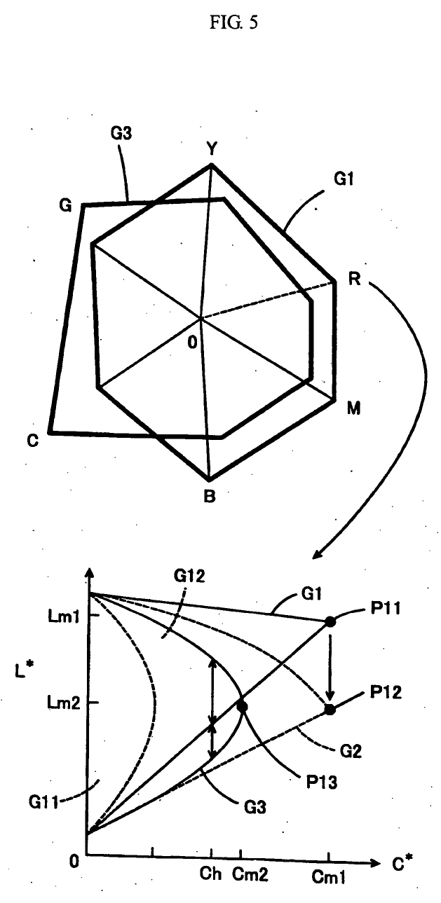

The upper half of FIG. 5 is an illustration showing the monitor gamut G1 and the printer gamut G3 as projected on the ab plane surface of the Lab color space, and RYGCBM (red, yellow, green, cyan, blue and magenta) represents the reference six hues (reference hues), and the original point O represents the projection point of the L axis (a=b=0). The lower half of FIG. 5 is an illustration showing the hues G1 and G3 on the C-L plane surface passing through the color saturation C axis and the lightness L axis in the R hue taking the monitor gamut G1 as the reference wherein the horizontal axis is a C axis and the vertical axis is a L axis. As the figure shows, when a mapping is made in such a way that the lightness at the maximum color saturation point P11 of the monitor gamut G1 in the same hue (R) agree with the lightness at the maximum color saturation point of the printer gamut G3, the overlapping of the post-mapping color gamut G2 and the printer gamut G3 increases particularly in the high color saturation area of the printer gamut. For example, the lightness range (shown by vertical arrows in both directions in the figure) of color saturation Ch (Co<Ch<Cm2, Co is border line color saturation described down below, Cm2 is the color saturation at the maximum color saturation point P13) in the high color saturation area of the printer gamut is wider in the overlapping part of the post-mapping color gamut G2 and the printer gamut G3 than in the overlapping part of the monitor gamut G1 and the printer gamut G3. In this way, it is possible to improve easily the gradation of lightness in the high color saturation area of color-converted images. In addition, in case where color saturation is emphasized at a second-stage mapping from the post-mapping gamut to the printer gamut, area requiring no emphasis of color saturation increases, and in this respect it will be possible to obtain color-converted images of a more natural image quality.

In the present embodiment, for a limited number of hues (six reference hues) among all the hues, the monitor gamut is mapped making the lightness at the maximum color saturation point of the monitor gamut agree with the lightness at the maximum color saturation point of the printer gamut in the same hues to specify the first correspondence relationship between the monitor gamut and the post-mapping gamut, and based on the first correspondence relationship specifying for the limited number of hues, the first correspondence relationship between the monitor gamut and the post-mapping gamut will be specified for the remaining intermediate hues except a limited number of hues among all the hues based on the first correspondence relationship specified for the limited number of hues.

A preferable mapping relating to the color saturation at the maximum color saturation point from the viewpoint of obtaining color-converted images of a good color reproducibility is a mapping that raises the color saturation at the maximum color saturation point of the monitor gamut above the color saturation at the maximum color saturation point of the printer gamut, and a more preferable mapping is a mapping that raises the color saturation at the maximum color saturation point of the monitor gamut to a level equal to or above the color saturation at the maximum color saturation point of the relevant monitor gamut. In case where the upper ceiling is set for color saturation, however, a preferable mapping is a mapping that maintains the color saturation at the maximum color saturation point of the monitor gamut.

In addition, in the present embodiment, the constant lightness area G11 on the low color saturation side of the monitor gamut G1 (the first predetermined area on the low color saturation side) is mapped for maintaining lightness, and the variable lightness area G12 excluding the constant lightness area G11 among the monitor gamut G1 is mapped for varying lightness.

The second correspondence specification unit U12 proceeds to the second stage mapping of the post-mapping gamut G2 on the printer gamut G3 for a same hue to specify the second correspondence relationship between the post-mapping gamut G2 and the printer gamut G3 and to generate the second correspondence relationship data 13b specifying the second correspondence relationship. Specifically, hue angles θ in the Lab color space are successively set and for each color angle θ, the post-mapping gamut G2 is mapped in the printer gamut G3. A preferable mapping from the viewpoint of obtaining color-converted images of a good color reproducibility is a mapping that maintains the intensity relationship of color saturation C and the intensity relationship of lightness L before and after the mapping in relation to the post-mapping gamut G2, and a more preferable mapping is a mapping that maintains the lightness at the maximum color saturation point P12 in the post-mapping gamut G2 before and after the mapping, and a more preferable mapping is a mapping that maintains lightness before and after the mapping in relation to the post-mapping gamut.

In the present embodiment, for a limited number of hues (six reference hues) among all the hues, the post-mapping gamut is mapped in the printer gamut to specify the second correspondence relationship between the post-mapping gamut and the printer gamut, and based on the second correspondence relationship specifying for the limited number of hues, the second correspondence relationship between the post-mapping gamut and the gamut will be specified for the remaining hues except the limited number of hues among all the hues.

And the constant color saturation area (the second predetermined area on the low color saturation side) G13 on the low color saturation side among the post-mapping gamut G2 is mapped for maintaining color saturation, and the variable color saturation gamut except the constant color saturation area G13 in the post-mapping area G2 is mapped for varying color saturation. Here, as the constant color saturation area G13 is the completely same area as the constant lightness area G11, the first and the second correspondence relationship is specified in such a way that both lightness and color saturation will be maintained for the predetermined area G11 (G13) on the low color saturation side among the monitor gamut G1.

The color conversation data making unit U13 specifies the correspondence relationship between the monitor gamut G1 and the printer gamut G3 based on the first correspondence relationship and the second correspondence relationship specified by each unit U11 and U12 to generate the third correspondence relationship data 13c specifying the correspondence relationship 13c, and generate a color-conversion LUT 14a based on the correspondence relationship 13c. Please refer to FIG. 3 in relation with the following description. Hue angles θ are successively set and for each hue angle θ combinations of color saturation C and lightness L of the monitor color gamut are successively set to obtain the combinations of color saturation C and lightness L of the post-mapping color gamut corresponding to the combinations acquired by referring to the first correspondence relationship data 13a, the combination of color saturation C and lightness L of the printer color gamut corresponding to the combination obtained by referring to the second correspondence relationship data 13b, and the third correspondence relationship data 13c can be generated by correlating the correspondence and the combination of C and L of the monitor gamut.

And please refer to FIG. 4 for the following description. To begin with, the amount of each color component L, a and b corresponding to the amount of color components for each color RGB at each grid point set in the RGB color space having RGB as color components in the monitor gamut is acquired by referring to the RGB-Lab correspondence data D1 correlating each color components of the RGB color space set at each grid point having RGB as color component in the monitor color gamut and each color component amount in the Lab color space. Then, the hue angles θ and color saturation C in the monitor gamut are acquired at each grid point, color saturation C and lightness in the printer color gamut are acquired by referring to the third correspondence relationship data 13c, and each color component amount L, a and b in the Lab color spaces are acquired from the θ, C and L in the printer color gamut to generate the RGB-Lab correspondence data D2 correlating the color component amount for each RGB and each color component amount L, a and b in the Lab color space in the printer gamut. In addition, a color conversion LUT 14a can be generated by correlating the amount of color components for each RGB at each grid point in the RGB color space and the color component amount of each RMYRVK by referring to the CMYRVK-Lab correspondence data D3 correlating the amount of each color component of the CMYRVK color space at each grid point set in the CMYRVK color space having CMYRVK as the amount of color component in the printer color gamut and the correlated CMYRVK-Lab correspondence data D3. The color conversion LUT 14a that has been made is an information table specifying the correspondence relationship between the gradation data composed of gradation values for each RGB and the gradation value expressed the amount of ink used in the printer for each CMYRVK for a plurality of reference points. The color conversion LUT 14a contains m³ number of gradation values for each color of CMYRVK when the number of grid points for each RGB is set at m (m is a integer of 2 or more, for example m=17).

As described above, the correspondence specification unit U1 maps the monitor gamut G1 for making the lightness Lm1 at the maximum color saturation point P11 in the monitor gamut G1 agree with the lightness Lm2 at the maximum color saturation point P13 in the printer gamut G3 in the same hue in the monitor gamut G1 and then maps the post-mapping gamut G2 in the printer gamut G3 to specify the correspondence relationship between the monitor gamut G1 and the printer gamut G3.

As described above, the color conversion unit U2 color converts the RGB data (the first image data) that express the gradation of color images in the monitor gamut by the gradation value of each RGB for each picture element into the amount of ink data (the second image data) that express color images in the printer gamut by the gradation value of each CMYRVK for each picture element according to the correspondence relationship specified. In the present embodiment the color conversion unit converts colors by referring to the color conversion LUT 14a.

As the process described above enables to increase the overlapping of the color reproduction gamut mapped from the color reproduction gamut of the first image equipment with the color reproduction gamut of the second image equipment especially in high color saturation area in the color reproduction gamut of the second image equipment, it will be possible to improve easily the gradation of light and shade in the high color saturation area in color-converted images. And the maintenance of the intensity relationship of lightness and color saturation in the color reproduction gamut of the first image equipment and the second image equipment leads to the constancy in the direction of variation in color saturation and lightness on the output side against variations in the amount of each color component (R, G, B) and color saturation and lightness obtained from the amount of each color component on the input side, in other words monotonous increase or monotonous decrease (monotonous variation) in color saturation and lightness on the output side. And therefore, it will be easy to design or create color in the color reproduction gamut of the first image equipment.

Up to now, for the correction of images in APL, a histogram is calculated for each color R, G, B. to correct the range of RGB for range correction, and to correct tone curve for each RGB channel. According to the present invention, it will be possible to improve the matching with automatic correction modules such as APL and APF (auto photo fine) for correcting images on the R, G, B. basis on the input side by making lightness or color saturation after color conversion increase or decrease monotonously.

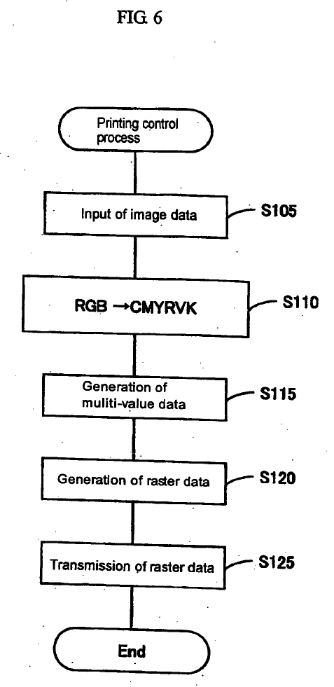

FIG. 6 is a flowchart showing a printing control process for controlling printing on a printer by using a color conversion LUT 14a that has been made. The PC 10 assigned to carry out the present processing constitutes a color conversion device and a printing control device, and S115-S125 corresponds to the printing control unit. In the first place, image data composed of gradation data corresponding to a plurality of component colors for each image element are inputted, and the image is converted into RGB data in the wide-area RGB color space expressing gradation by a plurality of picture elements for each RGB (Step S105, hereinafter “Step” is omitted) . Then, the image data are converted into RGB data of 256 gradations for each RGB (the first image data 13d) in the wide-area RGB color space according to the definition of sRGB and YUV color expressing system.

Then, the gradation data of each picture element constituting the RGB data are chosen as the object of conversion, and the RGB data are color converted into the amount of ink data (the second image data 13e) expressing by the gradation data for every CMYRVK corresponding to the color of ink used by the printer of the same number of picture elements as the RGB data (S110) by referring to the color conversion LUT 14a stored in the HD. The amount of ink data are printing data expressing images by gradation of a large number of dot matrix picture elements in the same way as the RGB data, and the gradation data for each picture element are data of 256 gradations for each CMYRVK indicating the amount of ink used discharged by the printer 20 from its printing head.

Then, for each picture element constituting the ink amount data, the number of gradations is decreased by carrying out the predetermined half-tone processing such as error diffusion method, dither method, density pattern method and the like on the ink amount data to form separate multi-value data CMYRVK having the same number of picture elements as the amount of ink data (S115). The multi-value data are data indicating the state of formation of dots by the presence or no of dots. For example, this can be indicated in the form of two-gradation binary data rendered binary according to the presence of dot represented by the gradation value of “1” and the absence of dot represented by the gradation value of “0”. Obviously, four gradation data and the like maybe adopted. Then, the multi-data for each color are rasterized as required to be rearranged in an order used by the printer to form raster data showing the state of dot formation by CMYRVK (S120). Then, the raster data are sent to the printer 20 (S125) to terminate the printing control process. In this way, the printer can be controlled to print images for printing (a type of color-converted image) corresponding to the ink amount data (the second image data).

The printer 20 acquires the raster data, discharges ink for each color for each picture element by driving the printing head based on the acquired raster data and adheres the ink on the printing medium. Then, dots of each ink color by the unit of picture element are formed on the printing medium, and images for printing (output images) corresponding to the amount of ink data are printed on the printing medium. Output images formed with converted colors have improved gradation in light and shade in the high color saturation areas and have a high image quality.

(2) Process of Making Color-Converted Data

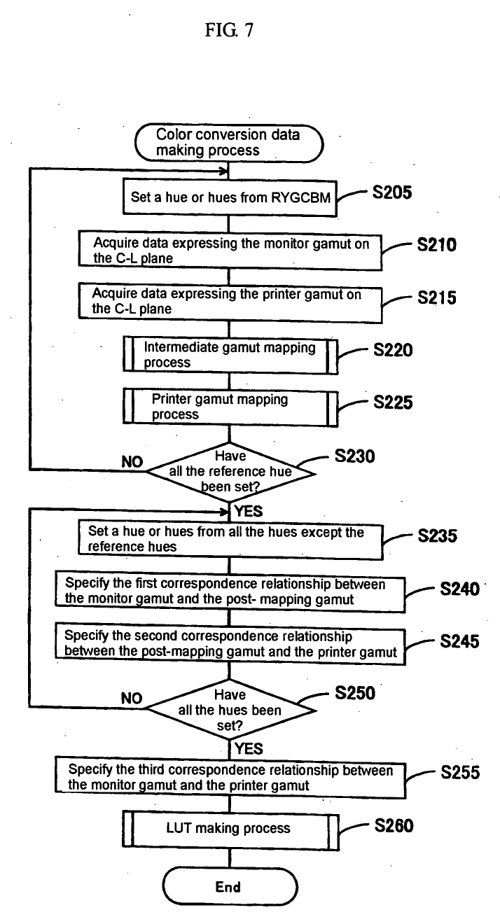

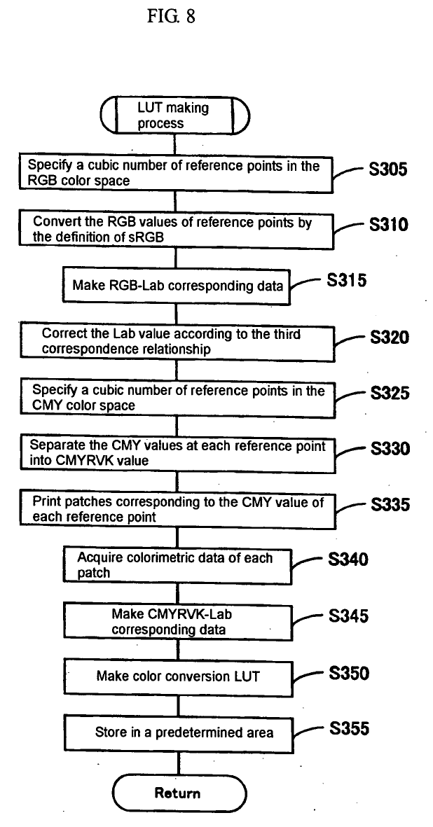

FIGS. 7 and 8 are flowcharts indicating the process of making color conversion LUT 14a by specifying the correspondence relationship between the monitor gamut and the printer gamut. The PC 10 assigned to perform the present processing constitutes the correspondence specification unit of a color conversion device and a color conversion data making device, S220 and S240 correspond to the first correspondence specification unit, S225 and dS245 correspond to the second correspondence specification unit, and S255 through 260 correspond to the color conversion data making unit. In addition, the PC 10 assigned to perform the present processing and the printing control processing described in S110 above constitutes a color conversion device. For the following description, please refer to FIGS. 1 through 5.

In the first place, the object hues (object hues) specifying the first and second correspondence relations of hues will be chosen (S205) among the six reference hues (reference hues) of RYGCBM. For example, a different value (for example hue angle θ) is assigned to each hue of RYGCBM, and the object hue can be selected from among the six reference hues by successively renewing the point value storing the hue. In the steps S220 and S225 described below, a mapping processing will be performed in the color saturation C-lightness L plane surface passing through the L axis in the Lab color space and parallel with the L axis.

Then, in the C-L plane surface in the object hue of the Lab color space, the monitor color reproduction gamut data consisting of combinations of C and L expressing the color reproduction gamut G1 of the monitor will be acquired (S210) If the monitor gamut is expressed in the RCB color space, for example, it is possible to determine the color reproduction gamut of the monitor by using the Lab color space as the reference by color converting the coordinate value (R, G, B.) of each point in the RGB color space into the coordinate value (L, a, b) of each point in the Lab color space according to the definition of the sRGB standards. In the course of this operation, it is possible to set each point in the RGB color space at a predetermined interval such as 16 gradations among 256 gradations for each color elements, and to color convert the RGB value (coordinate value) into the Lab value (coordinate value) by using a publicly known formula. In this case, it is possible to acquire the Lab value at each point in the monitor gamut at the hue angle θof the object hue, to acquire color saturation by C=(a²+b²)^{1/2} and to acquire thus the monitor color reproduction gamut data. For example, it is possible to set L at the predetermined interval such as that of 1, determine whether C exists or not in the Lab color space for each L that has been set, and when C exists in the Lab color space, the maximum value and the minimum value of the C are calculated, and the combination of C and L calculated is acquired and stored as the monitor color reproduction gamut data.

And the printer color reproduction gamut data consisting of the combination of C and L expressing the color reproduction area G3 of the printer are acquired in the C-L plane surface in the object hue of the Lab color space (S215) . When the printer uses each ink of CMYRVK, the coordinate values at each point (C, M, Y, R, V, K) in the CMYRVK color space at which the amount of ink used is indicated are processed with the predetermined half-tone process and the predetermined rasterizing process to form raster data, and a patch (color chip) at each such point is printed on the predetermined printing medium, and calorimetric values (L, a, and b) measured in the Lab color space with a calorimeter are acquired. In this way, the color reproduction gamut of the printer can be determined by using the Lab color space as the reference. In the course of this operation, each point in the CMY color space at predetermined intervals such as 16 gradations among the 256 gradations for each element colors CMY maybe set, the CMY value of each point may be converted into the CMYRVK values according to the predetermined color separation rule corresponding to the nature of each ink, the patch at each point may be printed by using the CMYRVK value to acquire the Lab value (calorimetric value) at each point. In this case, the Lab value of each point in the printer color gamut may be acquired at the hue angle θof the object hue, and color saturation may be calculated by C=(a²+b²)^{1/2} to acquire the printer color reproduction gamut data. For example, it is possible to acquire the printer color reproduction gamut data by setting L by the predetermined interval such as an interval of 1, determining whether C exists in the Lab color space or not for each L that has been set, and when C exists within the Lab color space, by calculating the maximum and the minimum of the C value, and by acquiring the combination of C and L that have been calculated.

Needless to say, the printer color gamut may be determined by referring to the printer profile.

Then, the intermediate gamut mapping process described further below will be carried out (S220), and the monitor color gamut G1 is mapped to make the lightness Lm1 at the maximum color saturation point P11 in the monitor gamut agree with the lightness Lm2 at the maximum color saturation point P13 in the printer color gamut G3 in the same hue for the object hues to generate the first correspondence relationship data 13a specifying the first correspondence relationship between the monitor color gamut G1 and the post-mapping color gamut G2. And then, the printer color gamut mapping processing described further below will be carried out. (S225), and the post-mapping color gamut G2 will be mapped in the printer color gamut G3 for the object hue to generate the second correspondence relationship data 13b specifying the second correspondence relationship between both gamuts G2 and G3.

And it will be judged whether all the six reference hues have been set as the object hues (S230). When the conditions have not been satisfied, the steps S205-S230 will be repeated, and when the conditions have been met, the whole process will proceed to the step S235.

In the step S235, the object hues specifying the first and second relationship of correspondence of hues among the hues excluding the six reference hues of all the hues marked by predetermined marks such as 1° of hue angle between 0° and 360° are set. While the detailed process will be described further below, with respect to the object hues, the first correspondence relationship data 13a will be generated to specify the first correspondence relationship between the monitor gamut G1 and the post-mapping gamut G2 based on the result of the intermediate gamut mapping process in S240. Then, regarding the object hues, the second correspondence relationship data 13b specifying the second correspondence relationship between the post-mapping gamut G2 and the printer gamut G3 based on the results of printer gamut mapping process in S225 will be formed (S245). And it will be judged whether all the hues have been set as the object hues (S250), and when the conditions have not been met, the steps S235-S250 will be repeated, and when the conditions have been met, the whole process will proceed to S255.

In the process S255, the third correspondence relationship data 13c that specified the correspondence relationship between the monitor gamut G1 and the printer gamut G3 based on the first and second correspondence relationship are created. And, the LUT making process shown in FIG. 8 is carried out to make a color conversion LUT 14a (S260) and to end the flow.

By the process shown above, the monitor gamut is mapped to make the lightness at the maximum color saturation point of the monitor gamut agree with the lightness at the maximum color saturation point of the printer gamut in the same hue for the limited six reference hue among all the hues, then the post-mapping gamut is mapped in the printer gamut to specify the correspondence relationship between the monitor gamut and the printer gamut, and the correspondence relationship between the monitor gamut and the printer gamut is specified for the remaining intermediate hues excluding the reference hues among all the hues based on the correspondence relationship specified for the reference hues. This will enable to improve easily gradation of light and shade in high color saturation area in the color-converted images outputted corresponding to the amount of ink data for the reference hues, and will increase the gamut where no intensification of color saturation is required when color saturation is to be intensified in the second-stage mapping. And, as the correspondence relationship with regard to the intermediate hues will be specified based on the correspondence relationship specified on the reference hues, it will be possible to specify promptly the correspondence relationship for all the hues.

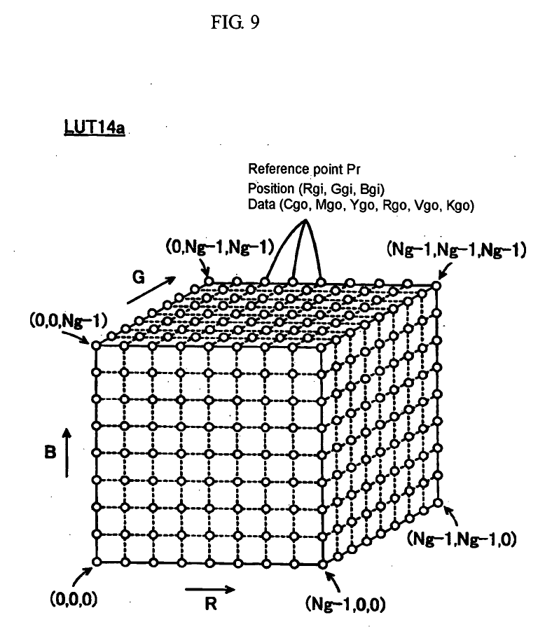

FIG. 9 shows the reference points (grid points) set in the RGB color spaces. When the work of making LUT begins, data specifying the position of reference points (RGB values) consisting of a cube of m (m is an integer of two or more) separated by an equal interval along each axis of the RGB color space are made (S305). The figure shows the position of the reference point Pr as (Rgi, Ggi, Bgi), the CMYRVK value stored in the reference points of each position as (Cgo, Mgo, Ygo, Rgo, Vgo, Kgo), and Ng as the number of gradations of the RGB values (for example 256). m may be 9, 17 and so forth. Then, the RGB values at reference points are converted into the amount of each color component (Lab value) in the Lab color space according to the definition of sRGB (S310). And the RGB-Lab correspondence data D1 specifying the correspondence relationship on the input side between the RGB value and the Lab value are prepared by storing the RGB value and the Lab value in RAM 13 and other predetermined areas (S315). Then, the Lab value of the RGB-Lab correspondence data D1 are corrected according to the third correspondence relationship data 13c to generate the RGB-Lab correspondence data D2 correlating the correspondence relationship on the input side and the correspondence relations between the gamut G1 and the gamut G3 (S320). When the Lab values corresponding to the RGB values at each reference point Pr are acquired from the data D1, the Lab values corresponding to the Lab values are acquired by referring to the third correspondence relationship data 13c, and the Lab values are correlated to the RGB values at each reference point Pr, the data D2 can be prepared.

And like S305, data specifying the positions of reference points (CMY values) consisting of a number equal to the cube of n (n is an integer of two or more) separated by almost uniform distance along each axis in the CMY color space are prepared (S325). CMY values may have gradation values such as 256 gradations for each CMY, and n may have 9, 17 or any other suitable values. Then, the CMY value at each grid point is separated into CMYRVK values according to the predetermined color separation rule corresponding to the characteristic of each ink (S330). The CMYRVK values may be color separated into gradations such as 256 gradations for each CMYRVK, and the CMYRVK value at each reference point is formed by substituting each gradation value of CMY1 by the gradation value of K1. And the color conversion device controls in such a way that each patch corresponding to the CMYRVK value at each reference point may be printed on the predetermined printing medium (S335). In other words, the device generates raster data by performing the predetermined half-tone process and the predetermined rasterizing process on the CMYRVK value at each reference point for which the amount of ink used is indicated, and sends the raster data to the printer 20. Then, the printer 20 receives the raster data, drives the printing head to discharge ink, to form dots corresponding to the CMYRVK values and to print a plurality of patches corresponding to each grid point on the printing medium.

Here, the PC operator measures the color of each patch with a calorimeter 40 under a predetermined light source such as the D50 light source (prescribed by CIE). In other words, the operator presses the color detecting unit 30a of the calorimeter on each patch to measure successively the color thereof. The PC obtains the results of color measurement composed of each Lab value in the Lab color space for all of the plurality of patches (S340), and stores them as CMYRVK-Lab correspondence data D3 in predetermined areas such as RAM (S345) Here, it may read the Lab value from the calorimeter through an I/F 17a, it may have the Lab value stored once on a FD 16a and read the same through the FD drive 16, or it may accept operating inputs by the keyboard 18b to obtain the Lab value.

Then, it correlates the RGB values with the CMYRVK values by using both correspondence data D2 and D3 and makes a color conversion LUT 14a (S350) . The device can generate a color conversion LUT 14a by obtaining the Lab values corresponding to the RGB values at each reference points Pr from the RGB-Lab correspondence data D2, obtaining the CMYRVK values corresponding to the Lab values by referring to the CMYRVK-Lab correspondence data D3, and by correlating the RGB values and the CMYRVK values at each reference point, it can generate a color conversion LUT 14a. Finally, the device stores the color conversion LUT 14b in the predetermined area such as HD14 and the like (S355) to end the process. The color conversion LUT is an information table specifying the correspondence relationship between the RGB data (the first image data) consisting of the gradation values for each first element color RGB and the amount of ink data (the second image data) consisting of the gradation values for each second element color CMYRVK for a plurality of reference points.

(3) intermediate Color Gamut Mapping Process

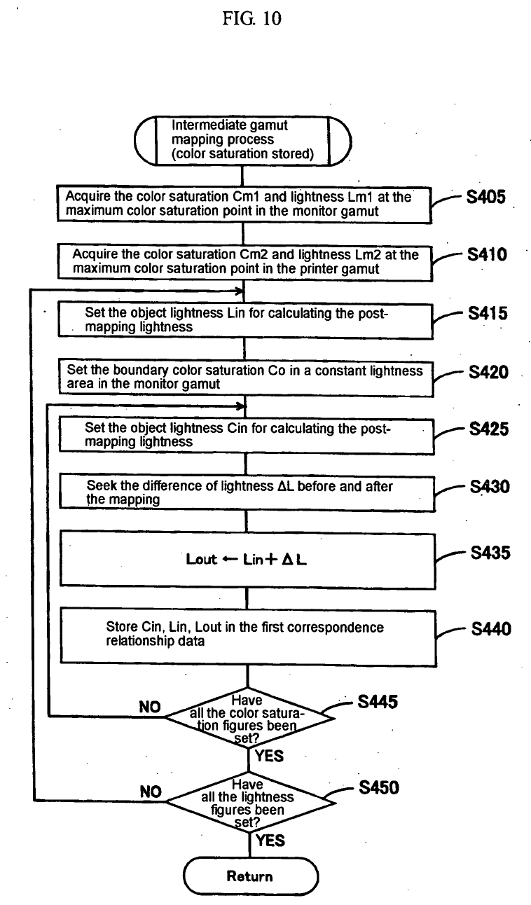

FIG. 10 is a flowchart showing the intermediate color gamut mapping process described in S220. In this process, the monitor gamut is mapped for preserving color saturation by making the color saturation agree before and after the mapping in the same hue (the above-mentioned object hue) to specify the first correspondence relationship.

To begin with, the color saturation Cm1 and the lightness Lm1 at the maximum color saturation point P11 of the monitor gamut for the object hue is acquired by referring to the monitor color reproduction gamut data representing the monitor gamut G1 in the C-L plane surface (S405). The combination of color saturation and lightness having the maximum color saturation maybe retrieved from among the monitor color reproduction gamut data, and the retrieved color saturation and lightness may be referred to as Cm1 and Lm1 respectively. Then, the color saturation Cm2 and lightness Lm2 at the maximum color saturation point P13 in the printer gamut are acquired by referring to the printer color reproduction gamut data representing the printer gamut G3 in the C-L plane surface (S410). The combination of color saturation and lightness having the maximum color saturation may be retrieved from among the printer color reproduction gamut data, and the retrieved color saturation and lightness may be called Cm2 and Lm2 respectively.

Then, the lightness Lin constituting the object of calculating the post-mapping lightness Lout is set in the range of values of possible lightness (lightness range) in the monitor gamut (S415). For example, the variable such as the minimum value Lmin (Lmin≧0)−the maximum value Lmax (Lmax≦100) of lightness in the color gamut is successively renewed by an interval of 1 or other predetermined interval on the rising order. Then, the color saturation Co on the boundary area between the constant lightness gamut G11 and the variable lightness gamut G12 in the monitor gamut are set (S420). For example, taking the maximum color saturation in the printer gamut at the object lightness Lin as Cplin, the positive predetermined coefficient as Nc (0<Nc<1, preferably 0.1≦Nc≦0.5, 0.2≦Nc≦0.4), the boundary color saturation Co is set by the following formula;
Co=Nc×Cplin (1)
In this case, the boundary between the gamut G11 and the gamut G12 will be similar to the one shown by a broken line curve in FIGS. 1 and 5. And Co may be set irrespective of Lin by the following formula;
Co=Nc×Cm2 (2)

In addition, the color saturation Cin constituting the object of calculating the post-mapping lightness Lout is set in the range of values of possible color saturation (color saturation range) for the lightness Lin within the monitor gamut (S425). For example, when the maximum color saturation having the object lightness Lin within the monitor gamut is set at Cdlin, the variable Cin is successively renewed at an interval of 1 or other specified interval in the rising order of 0-Cdlin. And the difference ΔL in lightness before and after the mapping is calculated by using the pre-mapping object color saturation Cin, the pre-mapping object color lightness Lin, the boundary color saturation Co, the color saturation at the maximum color saturation point Cm1 and Cm2, the lightness at the maximum color saturation point Lm1 and Lm2 (S430). Here, the function for calculating the difference in lightness ΔL before and after the mapping at the object lightness Lin is ΔL (Cin).

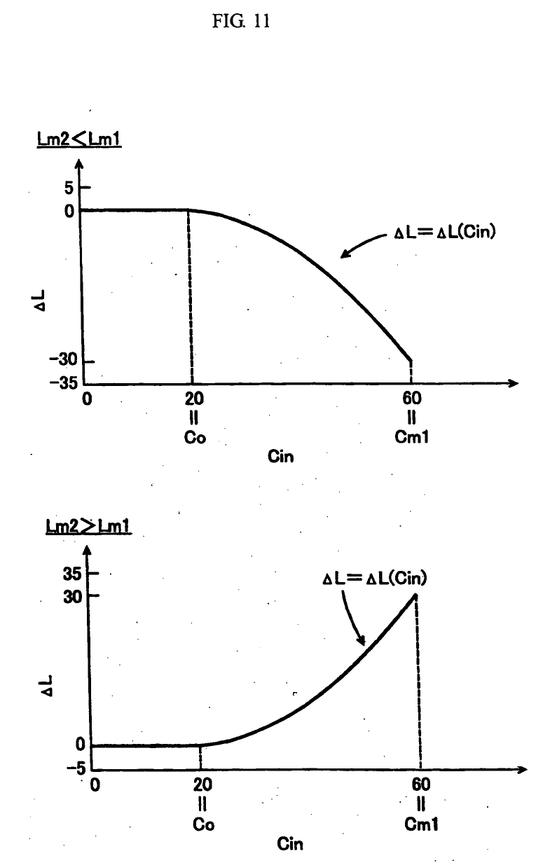

FIG. 11 are graphs showing examples of the curves ΔL=ΔL (Cin) on the difference in color saturation Cin−lightness ΔL plane surface. As the figure shows, the function ΔL (Cin) is 0 (zero) when 0≦Cin≦Co. When Co<Cin≦Cm1, the function ΔL (Cin) satisfies ΔL(Co)=0, ΔL (Cm1)=Lm2−Lm1, ΔL′ (Co)=0 (the inclination of curve for Cin=Co on the Cin−ΔL plane surface is 0 (zero)), and as shown on the upper half of the figure, in case where Lm2<Lm1, when Co<Cin<Cm1, always ΔL′ (Cin)<0 (the inclination of the curve is negative on the Cin−ΔL plane surface) and ΔL″ (Co)<0 (the curve is upward convex on the Cin−ΔL plane surface), and as shown in the lower half of the figure in the case where Lm2>Lm1, when Co<Cin<Cm1, always ΔL′ (Cin)>0 (the inclination of the curve is positive on the Cin−ΔL plane surface) and ΔL″ (Cin)>0 (the curve is downward convex on the Cin−ΔL plane surface). In addition, ΔL′ (Cin) is a function obtained by differentiating ΔL (Cin) by the variable Cin, and ΔL″ (Cin) is a function obtained by differentiating ΔL′ (Cin) by the variable Cin. Supposing that the function ΔL (Cin) is a secondary function in order to make the curve ΔL=ΔL (Cin) on the Cin−ΔL plane surface a secondary curve, and supposing fa=(Lm2−Lm1)/(Cm−Co)², fb=−2×fa×Co, fc=fa×Co², the following formula may be obtained;
ΔL(Cin)=fa×Cin²+fb×Cin+ fc (3)
Then, as the amount of calculation can be relatively reduced, it is possible to speed up the intermediate gamut mapping process by using a simple construction.

After calculating ΔL, the post-mapping lightness Lout is calculated by taking ΔL as the correction amount of lightness (variation amount of lightness) (S435).
Lout=Lin+ΔL (4)

After the calculation of Lout, the object color saturation Cin, the object lightness Lin, the post-mapping lightness Lout for the hue angle θ of the object hue are stored in the first correspondence relationship data 13a (S440). Please refer to FIG. 3 for the following description. When Cin and Lin are set in the j place from the top for the hue angle θi of the object hue, in response to the hue angle θi, the color saturation Cij in the monitor gamut and the color saturation Cij′ in the post-mapping gamut are changed into Cin, the lightness Lij in the monitor gamut is changed into Lin and the lightness Lij′ in the post-mapping gamut is changed into Lout. This rearrangement will specify the first correspondence relationship between the monitor gamut and the post-mapping gamut with regards to the points of object color saturation Cin and the object lightness Lin in the monitor gamut by object hue.

Then, it will be judged whether all the color saturations have be set as object color saturations or not (S445), and when the condition has not been met, the steps S425-S445 will be repeated, and when the condition has been met, the whole process proceeds to the step S450. In S450 it will be judged whether all the lightness intensities have been set as the object lightness intensities or not, and when the condition has not be met, the steps S415-S450 will be repeated, and when the condition has been met, the whole process will end.

According to the intermediate gamut mapping process mentioned above, mappings will be carried out with an intention to make the lightness Lm1 at the maximum color saturation point in the monitor gamut agree with the lightness Lm2 at the maximum color saturation point in the printer gamut. Because this increases the area of overlapping of the post-mapping gamut G2 and the printer gamut G3 especially in high color saturation areas, the gradation of light and shade in high color saturation areas in color-converted images can be easily improved, and in this respect it becomes possible to obtain color-converted images of more natural image quality. In addition, a second-stage printer gamut image processing carried out to increase color the intensity of color saturation results in an increase of area requiring no emphasis of color saturation, and in this respect it will be possible to obtain color-converted images of a more natural image quality.

And because the monitor gamut is mapped for preserving the color saturation thereof making the color saturation agree before and after the mapping (the intensity relationship of color saturation is maintained) wherein the intensity relationship of lightness is maintained before and after the mapping in the same hue, it is possible to ensure that the overlapping area of post-mapping gamut and printer gamut would increase in high color saturation areas. In this respect, even when an upper ceiling is set for the color saturation value used in the calculation by, for example, expressing color saturation in the specified range of gradation values, it is possible to improve easily the gradation of light and shade in high color saturation areas in color-converted images. In addition, since the inclination ΔL′ of the amount of lightness correction ΔL is defined to be 0 (zero) for the boundary color saturation Co, any difference in pre-mapping lightness in the same hue from the monitor gamut would bring about a one-to-one relationship and result in a mapping with a difference in post-mapping lightness, and as lightness does not vanish by the first-stage mapping, it is possible to improve easily the gradation of light and shade in high color saturation areas in color-converted images.

And, when the monitor gamut G1 is mapped, the variable lightness gamut G12 is mapped making the difference in lightness |ΔL| before and after the mapping so much greater as color saturation Cin is higher in the same hue. This will enable to obtain color-converted images of a more natural image quality. At that time, the variable lightness gamut G12 is mapped making the difference in lightness |ΔL′| before and after the mapping so much greater as color saturation Cin is higher in the same hue. Since higher color saturation images are, as viewed by the human eyes, perceived with less visual sensibility to light and shade, when a mapping is carried out by making the variation of difference in lightness before and after the mapping greater than the variation in color saturation as color saturation Cin is higher in the same hue in the variable lightness gamut G12 on the high color saturation side among the monitor gamut G1, it becomes possible to obtain color-converted images of a more natural image quality. And due to the fact that the lightness correction amount ΔL(Co) for the boundary color saturation Co is set at 0 (zero), and its inclination ΔL′ (Co) set also at 0 (zero), it becomes possible to obtain color-converted images of a more natural image quality. As a result of tests conducted, mappings carried out on the variable lightness gamut G12 by correcting lightness with a lightness correction amount ΔL obtained by using the function ΔL(Cin) described above in the same hue produced color-converted images of a particularly natural image quality.

(4) Printer Color Gamut Mapping Process

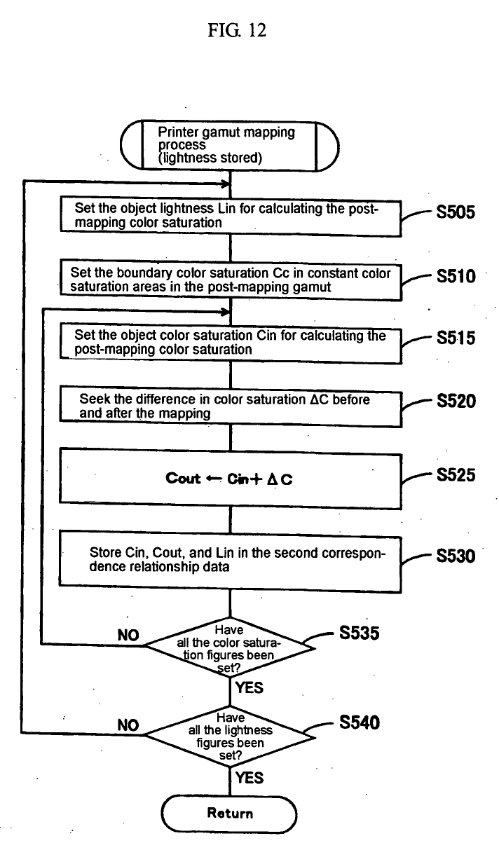

FIG. 12 is a flowchart showing the printer color gamut mapping process S225. In this process, the post-mapping gamut is mapped for preserving lightness by making the lightness before and after the mapping in the same hue (object hue described above) agree and the second correspondence relationship is specified.

To begin with, we will described the object hue. The object lightness Lin for calculating the post-mapping color saturation Cout is set from within the range of possible post-mapping gamut G2 (lightness range) (S505). For example, variable Lin may be successively renewed by rising order by an interval of 1 or other predetermined interval within the limit of the minimum value of lightness Lmin (Lmin≧0)−the maximum value of lightness Lmax (Lmax≦100) in the post-mapping gamut. Then, the boundary color saturation Cc is set between the constant color saturation gamut G13 and the variable color saturation gamut in the post-mapping gamut (S510). For example, like the above formula (1), taking the maximum color saturation in the printer gamut for the object lightness Lin as Cplin, the positive predetermined coefficient as Nc (0<Nc<1, preferably 0.1≦Nc≦0.5, 0.2≦Nc≦0.4), the boundary color saturation Cc is set by the following formula;
Cc=Nc×Cplin (5)
In this case, the constant color saturation gamut G13 will be the same gamut as the constant lightness gamut G11 when the formula (1) mentioned above is used.

In addition, the object color saturation Cin for calculating the post-mapping color saturation Cout will be set (color saturation range) from among the possible range of values for color saturation for the object lightness Lin within the post-mapping gamut (S515). For example, supposing the maximum color saturation for the object lightness Lin within the post-mapping gamut is Cmlin, the variable Cin can be successively renewed in a rising order by an interval of 1 or other predetermined intervals within the limit of 0−Cmlin. And, the difference in color saturation ΔC before and after the mapping is calculated by taking the object color saturation before the mapping Cin, the object lightness before the mapping Lin, the maximum color saturation in the post-mapping gamut for the object lightness Lin Cmlin, the maximum color saturation in the printer gamut for the object lightness Lin Cplin, and the boundary color saturation Cc (S520). Here, the function ΔC (Cin) for calculating the difference in color saturation ΔC before and after the mapping for the object color saturation Cin may be a linear function, for example,

When 0<Cin<Cc,
ΔC(Cin)=0

When Co<Cin<Cmlin,
ΔC(Cin)={(Cplin−Cc)/(Cmlin−Cc)}×(Cin−Cc)+Cc (6)

After the calculation of ΔC, taking ΔC as the correction amount of color saturation (variation amount of color saturation), post-mapping color saturation Cout is calculated (S525).
Cout=Cin+ΔC (7)

After the calculation of Cout, the color saturation Cin, the post-mapping color saturation Cout, and the object lightness Lin for the hue angle θ of the object hue are stored in the second correspondence relationship data 13b (S530). Please refer to FIG. 3 for the following description. When Cin and Lin are set as the item j from the top for the hue angle θi of the object hue, in response to the hue angle θi, the color saturation Cij′ in the post-mapping gamut is replaced by Cin, the color saturation Cij″ in the printer gamut is replaced by Cout, and the lightness Lij′ in the post-mapping gamut and the lightness Lij″ in the printer gamut are replaced by Lin. This will specify the second correspondence relationship between the post-mapping gamut and the printer gamut with respect to the object color saturation Cin and the object lightness Lin in the post-mapping gamut for the object hue.

Then, it will be judged whether all the color saturation intensities have been set as the object color saturation or not (S535). When the condition has not been met, the steps S515-S535 will be repeated, and when the condition has been met, the whole process will proceed to S540. In S540, it will be judged whether all the lightness intensities have been set for the object lightness or not. When the condition has not been met S505-S540 will be repeated, and when the condition has been met, the whole process will end.

(5) Process of Correlating the First and the Second Correspondence Relationships

When the intermediate gamut mapping process and the printer gamut mapping process for all the six reference hue have been completed, in S235 of FIG. 7 the object hues are set in finer tones, and in S240-S245 spline interpolation (linear interpolation and the like are also possible) and other predetermined interpolating calculation are used to specify the correspondence relationship between different types of gamut for the object hues.

In S240, for the hue angle θ of the object hue, the object color saturation Cin and the object lightness Lin are successively set, the amount of lightness correction ΔL from the monitor gamut G1 to the post-mapping gamut G2 is calculated by interpolating calculation for each object color saturation Cin and the object lightness Lin with reference to the first correspondence relationship data 13a generated according to the six reference hues to specify the first correspondence relationship between both types of gamut G1 and G2.

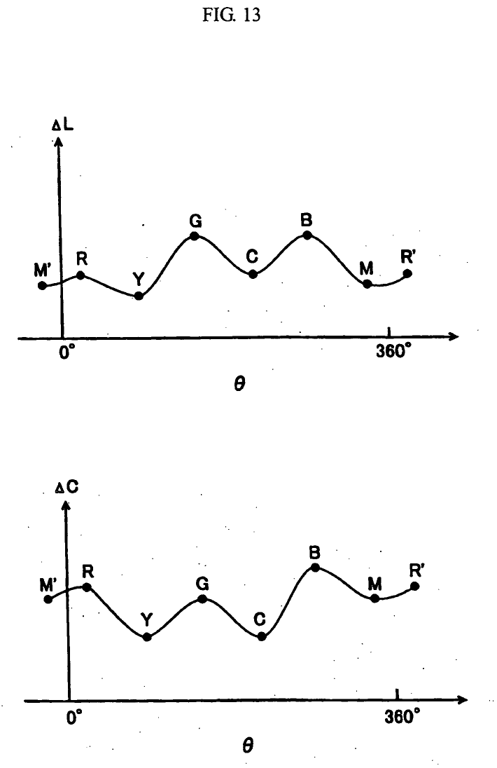

The upper half of FIG. 13 shows how the correction amount of lightness ΔL of both types of gamut G1 and G2 in the object color saturation Cin and the object lightness Lin for the hue angle θ are calculated by interpolating calculation. In the upper half, the points of the six reference hues RYGCBM coordinates (θ,ΔL), the points ranging from R with the smallest 0 to the large R′coordinate with a hue angle of 360° (θ+360, ΔL), the points ranging from M representing the maximum θ to the small M′ coordinate with hue angle 360° (θ−360°, ΔL) are plotted on the hue angle θ−lightness correction amount ΔL plane surface. And the upper half shows a curve ΔL=ΔL(θ) calculated by a spline interpolating calculation passing through the eight points M′RYGCBMR′ on the θ−ΔL plane surface by taking ΔL(θ) as the function of θ. Here, the lightness correction amount ΔL in the hue angle θi of the six reference hues can be calculated by Lin′−Lin, the lightness Lin′ in the post-mapping gamut for the object color saturation Cin and the object lightness Lin being read out from among the data corresponding to the hue angle θi from among the first corresponding relationship data 13a of FIG. 3. Then, ΔL=ΔL(θ) may be determined by spline interpolating calculation using θ and ΔL of M′RYGCBMR′, and the lightness correction amount ΔL can be calculated for each object color saturation Cin and object lightness Lin in the hue angle θ of the object hue.

Incidentally, even in the case of spline interpolating calculation, ΔL=ΔL(θ) can be determined and ΔL can be calculated by using θand ΔL of M′RYGCBMR′. In the case of linear interpolating calculation, the variation amount of lightness in two types of reference hues sandwiching (enclosing) an intermediate hue and the hue angle θ representing the hues of the two types of reference hues maybe used for the interpolating calculation, and the variation amount of lightness ΔL in the intermediate hue of the hue angle θ set may be calculated. For example, when the hue angle θ of the intermediate hue is greater than the hue angle of R and smaller than the hue angle of Y, the lightness correction amount ΔL1 of R and the hue angle θ1 of R, and the lightness correction amount ΔL2 of Y and the hue angle θ2 of R can be used to calculate the lightness correction amount ΔL in the hue angle θ of the intermediate hue.

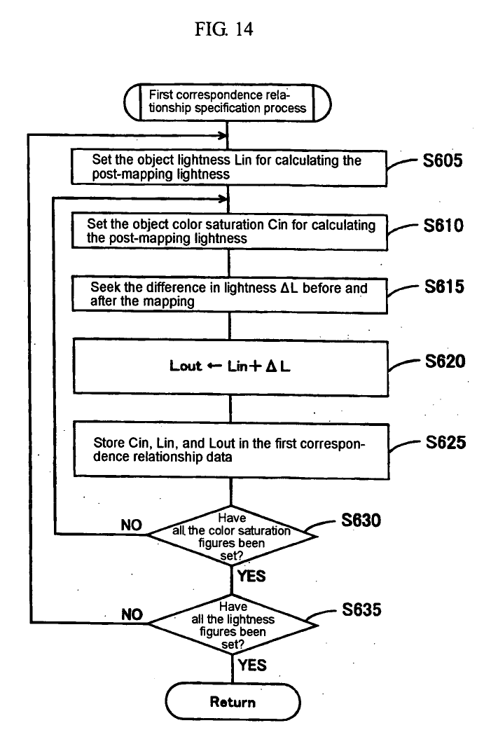

Therefore, as FIG. 14 shows, when the object lightness Lin for calculating the post-mapping lightness Lout is set from among the lightness range in the monitor gamut (S605), the object color saturation Cin for calculating the post-mapping lightness Lout is set from among the color saturation range in the object lightness Lin in the monitor gamut (S610), the difference in lightness ΔL before and after the mapping is calculated with reference to the lightness Lin′ of the post-mapping gamut for the object color saturation Cin and the object lightness Lin from among the first correspondence relationship data 13a corresponding to the hue angle θ of the object hue (S615), it is possible to calculate the post-mapping lightness Lout by using the formula described above (4) :Lout=Lin+ΔL (S620). When Lout is calculated, the object color saturation Cin, the object lightness Lin and the post-mapping lightness Lout for the hue angle θ may be stored in the first correspondence relationship data 13a (S625). Then, it is judged whether all the color saturation intensities have been set as the object color saturation intensities (S630). When the conditions have not been met, S610-S630 are repeated, and when the conditions have been met, the whole process proceeds to S635. In S635, it will be judged whether all the lightness intensities have been set as the object lightness intensities. When the conditions have not been met, S605-S630 will be repeated, and when the conditions have been met, the whole process ends.

In S245, the object color saturation Cin and the object lightness Lin for the hue angle θ of the object hues are successively set, and the color saturation correction amount ΔC from the post-mapping gamut G2 to the printer gamut G3 for each object color saturation Cin and the object lightness Lin is calculated by interpolating calculation with reference to the second correspondence relationship data 13b generated according to the six reference hues to specify the second correspondence relationship between both gamuts G2 and G3.

The lower half of FIG. 13 shows how the color saturation correction amount ΔC in both types of gamut G2 and G3 in the object color saturation Cin and the object lightness Lin for the hue angle θ is calculated by interpolating calculation. In the lower half also, the points of the six reference hues RYGCBM coordinates (θ,ΔC), the point of R′ coordinate (θ+360, ΔC), and the point of M′ coordinate (θ−360, ΔC) are plotted on the hue angle θ and color saturation correction amount ΔC plane surface, and shows a curve ΔC=ΔC (θ) calculated by spline interpolating calculation passing through M′RYGCBMR′ on the θand ΔC plane surface with ΔC(θ) as the function of θ. The color saturation correction amount ΔL in the hue angle θi of the six reference hues can be calculated from Cin′−Cin, with the color saturation Cin′ in the post-mapping gamut for the object color saturation Cin and the object lightness Lin being read out from the data corresponding to the hue angle θi from among the second correspondence relationship data 13b of FIG. 3. Thereupon, ΔC=ΔC (θ) can be determined by spline interpolating calculation using θ and ΔC of M′RYGCBMR′, and the color saturation correction amount ΔC can be calculated for each object color saturation Cin and the object lightness Lin in the hue angle θ of the object hue.

Incidentally, linear interpolating calculation can also be adopted. In the case of linear interpolating calculation, the amount of variation in two types of reference hues sandwiching (enclosing) an intermediate hue and the hue angle θ representing the hues of the two types of reference hues may be used for the interpolating calculation, and the amount of variation in color saturation may be set by the intermediate hue of the hue angle θ set.

The process of specifying the second correspondence relationship may be a similar process to that described in FIG. 14. Specifically, when the object lightness Lin for calculating the post-mapping color saturation Cout is set in the range of color saturation in the post-mapping gamut (corresponding to S605), the object color saturation Cin for calculating the post-mapping lightness Lout is set in the range of color saturation in the object lightness Lin within the post-mapping gamut (corresponding to S610), and the difference in lightness ΔL before and after the mapping is calculated by referring to the lightness Lin′ in the printer gamut for the object color saturation Cin and the object lightness Lin among the second correspondence relationship data 13b corresponding to the hue angle θof the object hue (corresponding to S615), the post-mapping color saturation Cout can be calculated by using the formula mentioned above (7) : Cout=Cin+ΔC (corresponding to S620). After the calculation of Cout, the object color saturation Cin, the post-mapping color saturation Cout, and the object lightness Lin for the hue angle θ may be stored in the second correspondence relationship data 13b (corresponding to S625).

When the correspondence relationship data 13a and b are generated for all the hues, in S255 of FIG. 7, the third correspondence relationship data 13c are generated by correlating both data 13a and b. In other words, the hue angle θserving as the object of correlating both data 13a and b are set successively, and for the hue angle set, combinations of color saturation C and lightness L in the monitor gamut G1 are set successively, the combinations of color saturation C and lightness L in the post-mapping gamut G2 corresponding to the combination of C and L set are obtained, the combination of color saturation C and lightness L in the printer gamut G3 corresponding to the combination of C and L in the post-mapping gamut 2 by referring to the second correspondence relationship data 13b, and when the combination of C and L in the monitor gamut set and the combination of C and L in the printer gamut obtained are correlated, the third correspondence relationship data 13c can be generated.

By the process described above, the amount of variation in at least one of lightness or color saturation before and after the mapping expressed by the correspondence relationship specified for the N=6 types of reference hues and the parameters expressing the hues specifying the correspondence relationship are used in a predetermined interpolating calculation to calculate the amount of variation in at least one of lightness and color saturation before and after the mapping for the intermediate hue, and to specify the correspondence relationship between the monitor gamut and the printer gamut so that the amount of variation in at least one of lightness or color saturation before and after the mapping for the intermediate hue may be the amount of variation obtained. In this way, it will be possible to improve easily the gradation of light and shade in high color saturation areas in color-converted images outputted in response to the amount of ink data without causing any degradation in color reproducibility of the output image in the monitor at the time of color reproduction by the printer, and it will be possible to obtain color-converted images of a more natural image quality.

And when the processing of making a LUT is conducted in S260, a color conversion LUT 14a is made. And when the printing control processing shown in FIG. 6 is carried out, the monitor gamut is mapped for making the lightness at the maximum color saturation point in the monitor gamut agree with the lightness at the maximum color saturation point in the printer gamut in the same hue, the post-mapping gamut is mapped in the printer gamut, the RGB data are color converted into the amount of ink data according to the correspondence relationship between the specified monitor and printer gamuts, and the printer is controlled to print the printing images corresponding to the color-converted amount of ink data. Then, the printer prints (outputs) printing images (output images) on the printing medium.

As described above, as the first-stage intermediate gamut mapping process enables to increase the overlapping area of post-mapping gamut and the printer gamut particularly in high color saturation areas, it will be possible to easily improve the gradation of light and shade in high color saturation areas in output images outputted after color conversion.

And in the second-stage printer gamut image processing, the post-mapping image is mapped for preserving lightness (for maintaining the intensity of light) by making the lightness agree before and after the mapping in the same hue, and therefore it is possible to maintain the gradation of lightness. In this respect, it will be possible to improve more easily the gradation of light and shade in high color saturation area in color-converted images (the output images described above).

Moreover, because a linear function ΔC (Cin) as shown in the formula (6) described above is used for correcting color saturation by means of printer gamut mapping process, mapping is carried out with a one-to-one relationship in that a difference in color saturation before the mapping is followed by a similar difference in post-mapping color saturation, and color saturation does not vanish in the second stage mapping. This enables to maintain the intensity relationship between both lightness and color saturation in the color reproduction area of the monitor and the printer, and therefore it becomes easy to design and create colors in the gamut of the monitor, i.e. the first image equipment.

And the correspondence relationship is specified in such a way that both lightness and color saturation may be maintained for the predetermined areas on the low color saturation side of the monitor gamut. Due to the specification of the correspondence relationship in such a way that at least one of lightness and color saturation may be maintained in the predetermined gamut, and because low color saturation colors which are important in terms of image quality such as colorlessness or flesh color do not change, it will be possible to obtain color-converted images of a better image quality.

And because of the correction of lightness by using the function mentioned above ΔL (Cin) in the intermediate gamut mapping process, it becomes possible to obtain color-converted images of a natural image quality.

In addition, as the correspondence relationship between hues other than the reference hues is calculated by interpolating calculations based on the data expressing the correspondence relationship among the reference hues, it is possible to maintain relatively in the printer gamut also the color saturation characteristics or the lightness characteristics in the monitor gamut without suffering impacts of any form in the printer gamut (any variation in color saturation in the monitor gamut is rivaled by a monotonous increase in color saturation in the printer gamut, while any variation in lightness in the monitor gamut is responded by a monotonous increase in lightness in the printer gamut).

(6) Variant

By the way, computers and peripherals available for carrying out the present invention may be configured in various ways. For example, a printing device may be integrated with a computer. It may be a printing device devoted for printing monochrome images. As for the process described above, a part or the whole process may be carried out by a printing device or a devoted image processing device.

The first image equipment on the input side can be applied not only to image displaying devices such as monitor but also to printing device, image generating device and the like. The second image equipment on the output side can be applied not only to printing devices such as printer but also image displaying device, image generating devices and the like.

The processing shown in FIG. 7 may be performed not only on all the hues but also on some hues only. Such cases are included in the present invention. For example, the processing shown in FIG. 7 may only be performed for the hue angle θ of color saturation Cm1 at the maximum color saturation point in the monitor gamut which is above the color saturation Cm2 at the maximum color saturation point in the printer gamut, and may prepare a color conversion LUT specifying the correspondence relationship between the monitor gamut and the printer gamut.

In specifying the first and the second correspondence relations for each object lightness and object color saturation with respect to object hue, color saturation may be specified before specifying lightness. Needless to say, the order of setting may be a rising order, a descending order or any other order.

The reference hues described above may be, in addition to mutually different six types of RYGCBM hues, mutually different N types (N is an integer of 3 or more) of hues such as RGB, CMY, RYGCB and the like. And in calculating the amount of variation in lightness or color saturation of intermediate hues by interpolating calculation, in addition to interpolating calculation by using the amount of variation in lightness and color saturation calculated for the whole N types of reference hues, interpolating calculation by using the amount of variation in lightness and color saturation calculated for a part of the N types of reference hues may be performed.

In specifying the first correspondence relationship, it is possible to specify the correspondence relationship by carrying out a mapping in such a way that the intensity relationship of lightness may not be reversed to the monitor gamut. Here, the state of intensity relationship of lightness not being reversed before and after the mapping is the state wherein, when any two freely chosen points P1 and P2 are taken in the color reproduction area before the mapping, and when the post-mapping points of P1 and P2 are represented by P1′ and P2′, if the lightness at the point P1 is greater than the lightness at the point P2, the lightness at the point P1′ is greater than the lightness at the point P2′, and if the lightness at the point P1 is less than the lightness at the point P2, the lightness at the point P1′ is less than the lightness at the point P2′, and if the lightness at the points P1 and P2 is equal, the lightness at the points P1′ and P2′ are also equal. Hereinafter, similar description applies.

And in specifying the first correspondence relationship, it is possible to specify the correspondence relationship by carrying out a mapping in which color saturation is not stored. For example, it is possible to adopt a setup of specifying the correspondence relationship by mapping the monitor gamut in such a way that the intensity relationship of color saturation may not be reversed from that of the monitor gamut.

In specifying the second correspondence relationship, it is enough to specify the correspondence relationship by carrying out a mapping not causing the loss of the lightness characteristics in anywhere other than the printer gamut (mapping of not storing color saturation), and the correspondence relationship may be specified by carrying out a mapping that does not store lightness. For example, it is possible to adopt a setup of specifying the correspondence relationship by mapping the post-mapping gamut in such a way that the intensity relationship in lightness and color saturation may not be reversed from that of the post-mapping gamut.

In the predetermined gamuts G11 and G13 on the low color saturation side described above, the correspondence relationship may be specified in such a way that only one of lightness or color saturation may be maintained. To maintain only lightness, it is enough for example to set the boundary color saturation Cc at 0 (zero) in the printer gamut mapping process. Then, as lightness does not change in the low color saturation area that is important in terms of image quality such as colorlessness or flesh color, it becomes possible to obtain images of a better image quality. And to maintain only color saturation, it is enough for example to set the boundary color saturation Co at 0 (zero) in the intermediate gamut mapping process. Then, as color saturation does not change in the low color saturation area that is important in terms of image quality, it becomes possible to obtain images of a better image quality.

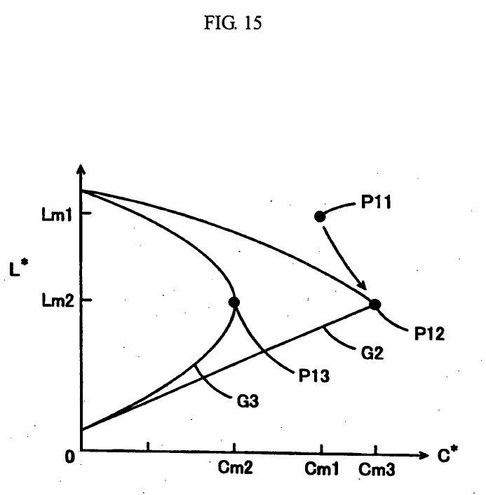

As FIG. 15 shows, in the intermediate gamut mapping process, it is possible to map the monitor gamut G1 in such a way that the post-mapping color saturation may be greater than the pre-mapping color saturation in the same hue to specify the correspondence relationship. As for the color saturation Cm1 at the maximum color saturation point P11 in the monitor gamut, it is possible to map in such a way that the color saturation expressed by gradation may be, for example, at the upper limit of gradation value Cm3 (Cm3>Cm1), and the monitor gamut G1 may be mapped in such a way that, taking the object color saturation as Cin, the post-mapping color saturation value Cout may be (Cm3/Cm1)×Cin. Even in this case, as it is possible to increase the area of overlapping of the post-mapping gamut and the printer gamut particularly in high color saturation areas, it will be possible to improve easily the gradation of light and shade in high color saturation areas in color-converted images.

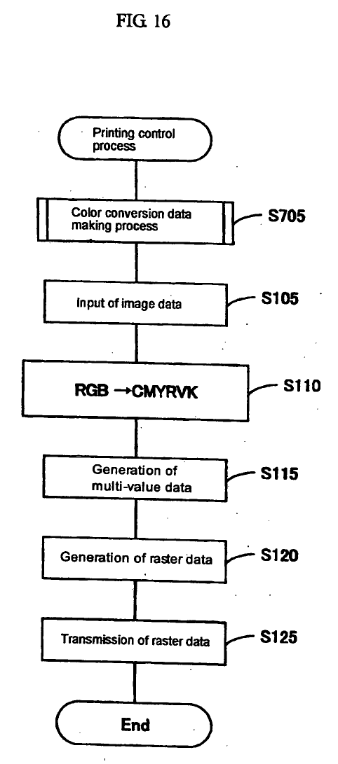

And as FIG. 16 shows, after the color conversion data making process shown in FIG. 7 has been completed (S705), it is possible to adopt the setup of proceeding to the printing control process same as S105-S125 shown in FIG. 6 in the same stroke.

As described above, even if a color conversion LUT is made by applying the present invention and printing control processing is effectuated every time image data are inputted, because of the possibility to increase overlapping areas of post-mapping gamut and printer gamut especially in high color saturation areas, it becomes possible to improve easily the gradation of light and shade in high color saturation areas in color converted images.

The present invention is applicable also as color conversion data having a structure of specifying the correspondence relationship between the color reproduction areas in the monitor gamut and that in the printer gamut for a plurality of reference points by mapping the monitor gamut for making the lightness at the maximum color saturation point in the monitor gamut agree with the lightness at the maximum color saturation point in the printer gamut while maintaining the intensity relationship in color saturation and the intensity relationship in lightness before and after the mapping in the same hue, and by carrying out a mapping for maintaining the lightness at the maximum color saturation point in the post-mapping color reproduction areas before and after the mapping while maintaining the intensity relationship in color saturation and the intensity relationship in lightness in the same hue before and after the mapping. And the present invention is also applicable as computer readable recording medium on which the color conversion data are recorded.

1. A color conversion method for color converting first image data expressing color image in a color reproduction gamut of a first image equipment into second image data expressing color image in a color reproduction gamut of a second image equipment, comprising:
color converting said first image data into said second image data according to a correspondence relationship between the color reproduction gamut of said first image equipment and that of said second image equipment, said relationship being specified by: mapping the color reproduction gamut of said first image equipment in such a way as to make the lightness at the maximum color saturation point in the color reproduction gamut of said first image equipment agree with the lightness at the maximum color saturation point in the color reproduction gamut of said second image equipment while keeping the same hue before and after the mapping; and thereafter mapping the post-mapping color reproduction gamut in the color reproduction gamut of said second image equipment.

2. The color conversion method according to claim 1, further comprising:
specifying a correspondence relationship between the color reproduction gamut of said first image equipment and that of said second image equipment by: mapping the color reproduction gamut of said first image equipment in such a way as to make the lightness at the maximum color saturation point in the color reproduction gamut of said first image equipment agree with the lightness at the maximum color saturation point in the color reproduction gamut of said second image equipment while keeping the same hue before and after the mapping; and thereafter mapping the post-mapping color reproduction gamut in the color reproduction gamut of said second image equipment,
color converting said first image data into said second image data according to said correspondence relationship.

3. The color conversion method according to claim 2, further comprising:
mapping the color reproduction gamut of said first image equipment for making the lightness at the maximum color saturation point in the color reproduction gamut of said first image equipment agree with the lightness at the maximum color saturation point in the color reproduction gamut of said second image equipment in the same hue thereby to specify the first correspondence relationship between the color reproduction gamut of said first image equipment and said post-mapping color reproduction gamut,
mapping said post-mapping color reproduction gamut in the color reproduction gamut of said second image equipment in the same hue thereby to specify the second correspondence relationship between said post-mapping color reproduction and that of said second image equipment, and
specifying the correspondence relationship between the color reproduction gamut of said first image equipment and that of said second image equipment according to said first correspondence relationship and said second correspondence relationship.

4. The color conversion method according to claim 2, further comprising:
for some hues among all the hues,
mapping the color reproduction gamut of said first image equipment for making the lightness at the maximum color saturation point in the color reproduction gamut of said first image equipment agree with the lightness at the maximum color saturation point in the color reproduction gamut of said second image equipment in the same hue;
mapping said post-mapping color reproduction gamut in the color reproduction gamut of said second image equipment thereby to specify the correspondence relationship between the color reproduction gamut of said first-image equipment and that of said second image equipment; and
based on the correspondence relationship specified for said limited number of hues, specifying the correspondence relationship between the color reproduction gamut of said first image equipment and that of said second image equipment for the remaining hues excluding said limited number of hues from among all the hues.

5. The color conversion method according to claim 4,
wherein
said limited number of hues are mutually different N types (N is an integer of 3 or more) of reference hues and said remaining hues are considered to be intermediate hues except said N types of reference hues from among all the hues,
wherein the method further comprising:
performing the prescribed interpolating calculation using the amount of variation in at least one of lightness or color saturation before and after the mapping expressed by the correspondence relationship specifying at least a part of said N types of reference hues and the parameters expressing the hues specifying said correspondence relationship to obtain the amount of variation in at least one of lightness or color saturation before or after the mapping regarding said intermediate hues, and
specifying the correspondence relationship between the color reproduction gamut of said first image equipment and that of said second image equipment in such a way that the amount of variation in at least one of lightness or color saturation before and after the mapping for said intermediate hues may be said amount of variation obtained.

6. The color conversion method according to claim 5,
wherein
said first image equipment is an image display device and said second image equipment is a printing device, and
said reference hues are six types of hues comprising red, yellow, green, cyan, blue and magenta,
wherein the method further comprising:
regarding said six types of reference hues, mapping the color reproduction gamut of said first image equipment for making the lightness at the maximum color saturation point in the color reproduction gamut of said first image equipment agree with the lightness at the maximum color saturation point in the color reproduction gamut of said second image equipment,
calculating the variation in lightness thereby to specify the first correspondence relationship between the color reproduction gamut of said first image equipment and said post-mapping color reproduction gamut,
regarding said remaining hues, setting the object hues for successively carrying out mapping,
regarding the hues set, performing a predetermined interpolating calculation using the amount of variation in lightness calculated for at least a part of said six types of reference hues and the hue angle indicating the hues for which said amount of variation has been calculated thereby to obtain the amount of variation in lightness,
regarding said hues set, specifying the first correspondence relationship between the color reproduction gamut of said first image equipment and said post-mapping color reproduction gamut in such a way that the amount of variation in lightness before and after the mapping may be said amount of variation obtained.

7. The color conversion method according to claim 2, further comprising:
mapping the color reproduction gamut of said first image equipment for increasing the post-mapping color saturation above the pre-mapping color saturation while maintaining the intensity relationship of lightness before and after the mapping in the same hues thereby to specify said correspondence relationship.

8. The color conversion method according to claim 7, further comprising:
mapping the color reproduction gamut of said first image equipment for making color saturation before and after the mapping agree in the same hues thereby to specify said correspondence relationship.

9. The color conversion method according to claim 7, further comprising:
mapping the post-mapping gamut for maintaining the intensity relationship of lightness before and after the mapping in the same hues thereby to specify said correspondence relationship.

10. The color conversion method according to claim 9, further comprising:
mapping the post-mapping gamut for maintaining the intensity relationship of color saturation before and after the mapping in the same hues thereby to specify said correspondence relationship.

11. The color conversion method according to claim 9, further comprising:
specifying said correspondence relationship in such a way that at least one of lightness or color saturation for the predetermined areas on the low color saturation side among the color reproduction gamut of said first image equipment may be maintained.

12. The color conversion method according to claim 9, further comprising:
mapping the color reproduction gamut of said first image equipment for increasing so much more the difference in lightness before and after the mapping as color saturation is greater in the same hues in the variable lightness gamut where lightness is varied before and after the mapping in the color reproduction gamut of said first image equipment thereby to specify said correspondence relationship.

13. The color conversion method according to claim 12, further comprising:
mapping said variable lightness gamut for increasing so much more the variation in difference in lightness before and after the mapping against the variation in color saturation as color saturation is higher in the same hue thereby to specify said correspondence relationship.

14. The color conversion method according to claim 13,
wherein
said variable lightness area is an area except the predetermined area on the low color saturation side among the color reproduction gamut of said first image equipment,
wherein
the method further comprising:
mapping in said variable lightness area for making post-mapping lightness equal to Lin+ΔL1 to specify said correspondence relationship by using the function ΔL (Cin) for calculating the difference in lightness ΔL before and after the mapping,
the function ΔL (Cin) satisfying;
ΔL(Co)=0, ΔL(Cm1)=Lm2−Lm1 t, (i)
(ii) The inclination of the curve ΔL=ΔL(Cin) in Cin=Co on the plane surface Cin−ΔL is 0.
and,
(iii) in the case of Lm2<Lm1 and when Co<Cin<Cm1, the inclination of ΔL=ΔL(Cin) on the plane surface Cin−ΔL is always negative and the curve ΔL=ΔL(Cin) is convex upward, in the case of Lm2>Lm1 and when Co<Cin<Cm1, the inclination of ΔL=ΔL (Cin) on the plane surface Cin−ΔL is always positive and the curve ΔL=ΔL(Cin) is convex downward, where the color saturation before the mapping is represented by Cin, the lightness before the mapping by Lin, the color saturation at the boundary between said variable lightness area and said predetermined area by Co, the color saturation at the maximum color saturation point in the color reproduction gamut of said first image equipment by Cm1, the lightness at said maximum color saturation point by Lm1, the lightness at the maximum color saturation point in the color reproduction gamut of said second image equipment by Lm2.

15. A color conversion device for color converting first image data expressing color image in a color reproduction gamut of a first image equipment into second image data expressing color image in a color reproduction gamut of a second image equipment, comprising:
a unit for color converting said first image data into said second image data according to a correspondence relationship between the color reproduction gamut of said first image equipment and that of said second image equipment, said relationship being specified by: mapping the color reproduction gamut of said first image equipment in such a way as to make the lightness at the maximum color saturation point in the color reproduction gamut of said first image equipment agree with the lightness at the maximum color saturation point in the color reproduction gamut of said second image equipment while keeping the same hue before and after the mapping; and thereafter mapping the post-mapping color reproduction gamut in the color reproduction gamut of said second image equipment.

16. A printing control device for converting the first image data expressing color images in the color reproduction gamut of an image display device into the second image data expressing color images in a color reproduction gamut of a printing device, the printing control device comprising:
a correspondence specification unit for specifying a correspondence relationship between the color reproduction gamut of said image display device and that of said printing device by: mapping the color reproduction gamut of said image display device in such a way as to make the lightness at the maximum color saturation point in the color reproduction gamut of said image display device agree with the lightness at the maximum color saturation point in the color reproduction gamut of said printing device while keeping the same hue before and after the mapping; and thereafter mapping the post-mapping color reproduction gamut in the color reproduction gamut of said printing device;
a color conversion unit for color converting said first image data into said second image data according to said correspondence relationship; and
a printing control unit for controlling said printing device to print printing images corresponding to the color-converted second image data.

17. A medium for recording color conversion program making a computer execute a function of color converting first image data expressing color image in a color reproduction gamut of a first image equipment into second image data expressing color image in a color reproduction gamut of a second image equipment,
the program making a computer execute the function of: color converting said first image data into said second image data according to a correspondence relationship between the color reproduction gamut of said first image equipment and that of said second image equipment, said relationship being specified by: mapping the color reproduction gamut of said first image equipment in such a way as to make the lightness at the maximum color saturation point in the color reproduction gamut of said first image equipment agree with the lightness at the maximum color saturation point in the color reproduction gamut of said second image equipment while keeping the same hue before and after the mapping; and thereafter mapping the post-mapping color reproduction gamut in the color reproduction gamut of said second image equipment.
